(19) United States
(12) Patent Application Publication
(10) Pub. No.: US 2006/0269346 A1
(43) Pub. Date: Nov. 30, 2006

(54) Cutting device and sheet processing apparatus

(75) Inventor: Masaji Takayama, Nagano-ken (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION

(21) Appl. No.: 11/438,003

(22) Filed: May 18, 2006

(30) Foreign Application Priority Data
May 27, 2005 (JP) 2005-155593

(51) Int. Cl. B41J 15/00

(52) U.S. Cl. 400/613

(57) ABSTRACT

A cutting device performs cutting processing on a sheet for separated characters by reciprocating a cutting tool forward and backward in a direction which is orthogonal to a feed direction of the sheet for separated characters while the sheet for separated characters is fed forward and backward along a sheet feed path by a sheet feed section. The cutting device includes a sheet accommodating section which accommodates the sheet for separated characters which is fed forward and backward so that the sheet can be loaded into and unloaded from the sheet accommodating section. The sheet accommodating section has a take-up drum which winds up the fed sheet for separated characters into a roll shape and a power supply section which supplies the power for rotating the take-up drum for take-up.

The entire disclosure of Japanese Patent Application No. 2005-155593, filed May 27, 2005, is expressly incorporated by reference herein.

### BACKGROUND

1. Technical Field

The present invention relates to a cutting device and a sheet processing apparatus which perform cutting processing on a sheet for separated characters, while the sheet for separated characters is fed forward and backward along a sheet feed path.

2. Related Art

In the related art, there is known a cutting device (tape processing apparatus) which performs cutting processing on a sheet for separated characters (cutting tape), while the sheet for separated characters is fed forward and backward. This type of cutting device is provided with a sheet accommodating section which accommodates a sheet for separated characters while winding an end of the sheet for separated characters, which is fed backward, into a roll shape. The sheet accommodating section has a winding guide which guides the winding of a sheet end, and the sheet for separated characters which is fed backward by the sheet accommodating section is guided to the winding guide, and is wound into a roll shape (see JP-A-2004-255825).

However, in a long sheet for separated characters which is wound into a plurality of overlapped sheets, friction occurs between the sheets to be wound and the feed load increases. Therefore, it is difficult to wind a long sheet for separated characters into a plurality of overlapped sheets by using (reverse) only the feed of the sheet for separated characters as a conventional cutting device.

### SUMMARY

An advantage of some aspects of the invention is that it provides, even with a long sheet for separated characters, a cutting device and a sheet processing apparatus capable of efficiently winding and accommodating the sheet into a roll shape.

According to an aspect of the invention, there is provided a cutting device which performs cutting processing on a sheet for separated characters by reciprocating a cutting tool forward and backward in a direction which is orthogonal to a feed direction of the sheet for separated characters while the sheet for separated characters is fed forward and backward along a sheet feed path by a sheet feed section. The cutting device includes a sheet accommodating section which accommodates the sheet for separated characters which is fed forward and backward so that the sheet can be loaded into and unloaded from the sheet accommodating section. The sheet accommodating section has a take-up drum which winds up the fed sheet for separated characters into a roll shape and a power supply section which supplies the power for rotating the take-up drum for take-up.

According to this configuration, the take-up drum can be rotated for take-up by the power supply section to wind a sheet for separated characters fed to the sheet accommodating section around the peripheral surface of the take-up drum. In this way, even if a long sheet for separated characters requires a plurality of repeated take-up operations, the sheet can be efficiently wound up against the friction between the sheets by positively rotating the take-up drum for take-up.

In addition, in order to improve an efficient take-up of a sheet for separated characters by the sliding resistance between (peripheral surface of) the take-up drum and the sheet for separated characters, it is preferable that the peripheral surface of the take-up drum be made of rubber, etc. having a large sliding resistance with the sheet for separated characters.

Preferably, the sheet accommodating section may further include a biasing member which biases the sheet for separated characters against a peripheral surface of the take-up drum.

According to this configuration, since a sheet for separated characters is biased against the peripheral surface of the take-up drum by the biasing member, the sliding resistance between the take-up drum and a sheet for separated characters can be effectively utilized, and the sheet for separated characters fed to the sheet accommodating section can be efficiently wound up around the take-up drum.

Preferably, the power supply section may have a torque limiter which limits a rotational torque at the time of take-up of the take-up drum.

According to this configuration, since the rotational torque of the take-up drum at the time of take-up of a sheet for separated characters is limited by the torque limiter, excessive take-up of the sheet for separated characters fed to the sheet accommodating section can be prevented. That is, the take-up of the sheet for separated characters can be performed in such a manner as to correspond to the feed rate of the sheet for separated characters, and excessive tension can be prevented from being applied to the sheet for separated characters due to the take-up by the take-up drum. Therefore, even if the take-up of the sheet for separated characters is performed during the cutting processing, the cutting processing can be prevented from being affected by this take-up.

Preferably, the sheet feed section may have a sheet feed roller which rotates forward and backward to feed the sheet for separated characters forward and backward. The power supply section may have a reversible motor and a power transmission mechanism which transmits the power of the motor to the take-up drum. The power transmission mechanism may transmit the forward and backward torque of the motor to the sheet feed roller.

According to this configuration, the power of the motor which rotates the take-up drum for take-up is transmitted also to the sheet feed section. Therefore, take-up rotation of the take-up drum and sheet feed rotation of the sheet feed roller can be synchronized with each other, and the take-up rotation of the take-up drum can be performed appropriately such that it corresponds to the feed operation of the sheet for separated characters.

Preferably, the power transmission mechanism may have a one-way clutch which transmits the forward and backward torque of the motor only in the direction of take-up of the take-up drum.

According to this configuration, the power of the motor is transmitted only in the direction of the take-up of the take-up drum. That is, since the sheet for separated characters wound up by the take-up drum is supplied by the feed for the cutting processing, cutting processing can be prevented from being affected in the case of excess or deficient supply of the sheet for separated characters.

Preferably, the sheet accommodating section may further include a housing member which accommodates the take-up drum, and an inner peripheral surface of the housing member is formed on a circle concentric with the take-up drum.

According to this configuration, the inner peripheral surface of the housing member can be used as a guide when the sheet for separated characters is wound up, and the sheet for separated characters can be appropriately wound up around the peripheral surface of the take-up drum.

According to another aspect of the invention, there is provided a sheet processing apparatus including any one of the above-mentioned cutting devices and a printer which performs printing on the sheet for separated characters.

According to this configuration, both the printing processing and the cutting processing can be performed on the sheet for separated characters, and various kinds of processing can be performed on the sheet for separated characters. In this case, since the cutting device applied to the sheet processing apparatus is any one of the above-mentioned cutting devices, it is possible to handle a long sheet for separated characters.

### BRIEF DESCRIPTION OF THE DRAWINGS

The invention will be described with reference to the accompanying drawings, wherein like numbers reference like elements.

FIG. 1 is a perspective view showing an appearance of a tape processing apparatus with its lid closed.

FIG. 2 is a sectional view of the tape processing apparatus.

FIG. 3 is a sectional view of the tape processing apparatus when being cut around a common support frame in a horizontal plane.

FIG. 4 is an explanatory view of a power system in a full cutting unit and a width guide mechanism.

FIG. 5 is a sectional view when a cutting unit is cut in a direction perpendicular to a tape feed path.

FIG. 6 is an external perspective view around a cutting mechanism as seen from the upper frame side.

FIG. 7 is an external perspective view around the cutting mechanism as seen from the downstream side in a tape feed direction.

FIG. 8 is a sectional view of the tape processing apparatus when being cut around the cutting mechanism in a horizontal plane.

FIG. 9 is an explanatory view of a power system in a cutting feed mechanism and a tape accommodating mechanism.

FIG. 10 is a control block diagram of the tape processing apparatus.

FIGS. 11A to 11F illustrate tape strips created by half-cutting processing: FIGS. 11A to 11C show tape strips when simple half-cutting processing has been performed, and FIG. 11D to 11F show tape strips when decorative half-cutting processing has been performed. In addition, half-cutting lines are indicated by broken lines.

FIGS. 12A to 12F illustrate tape strips created by clipping processing: FIGS. 12A and 12B shows tape strips when only the cutting processing has been performed, and FIGS. 12C to 12F show tape strips when printing decoration cutting processing has been performed.

### DESCRIPTION OF EXEMPLARY EMBODIMENTS

Hereafter, embodiments of the invention will be described with reference to the accompanying drawings. After this tape processing apparatus supplies a processing tape (tape with a separate paper) in which a tape for separated characters and a peelable tape are laminated to each other, from a tape cartridge to perform a printing processing, the tape strip in which the so-called separated characters (including symbols and figures) are formed is created by cutting and separating the printed portion with a full-cutting process and further performing cutting processing which forms cut lines in the separated tape strip.

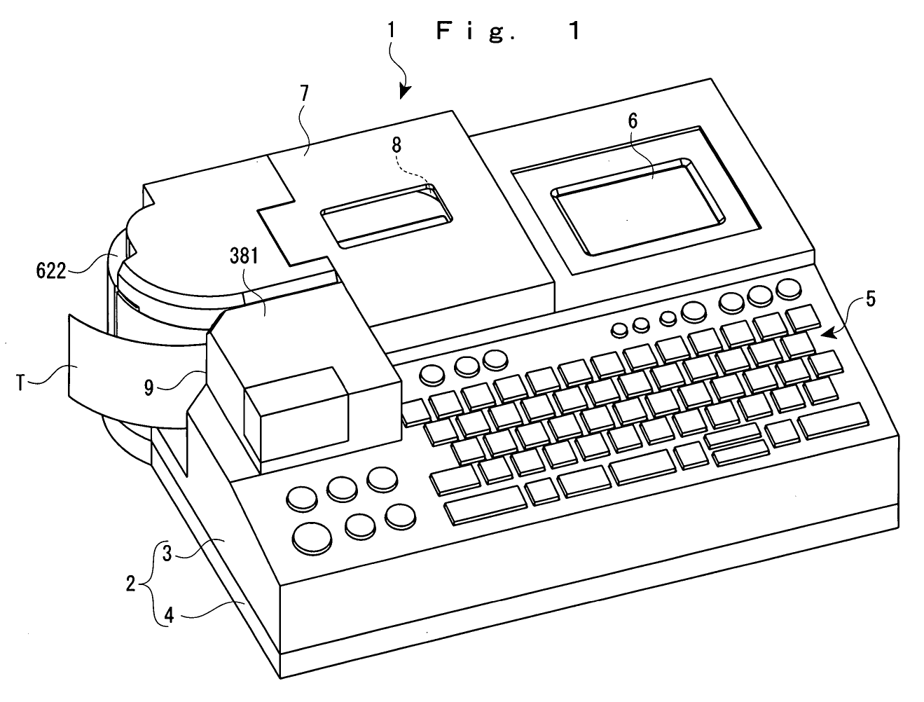

FIG. 1 is a perspective view showing an appearance of a tape processing apparatus. As shown in FIG. 1, the outer shell of the tape processing apparatus 1 is composed of an apparatus case 2 having an upper case 3 and a lower case 4. On the front side of the top face of the upper case 3, a keyboard 5 for various kinds of data input having a plurality of keys is disposed. A display 6 is built in a right portion on the rear side of the top face of the upper case 3, while a cartridge opening and closing lid 7 which forms a portion of the upper case 3 is adjacent to the left side of the display 6. A cartridge mounting part 8 on which a tape cartridge C is detachably mounted formed within the cartridge opening and closing lid 7. Moreover, a tape ejecting slot 9 through which a processed processing tape T is ejected is formed at the left lateral face of the upper case 3.

In addition, reference numeral 381 in FIG. 1 is a cutting tool replacement lid 381 for the replacement of a cutting tool 142 as will be described later, and reference numeral 622 is an accommodating section opening and closing lid for opening the tape accommodating section 601 (not shown: described later).

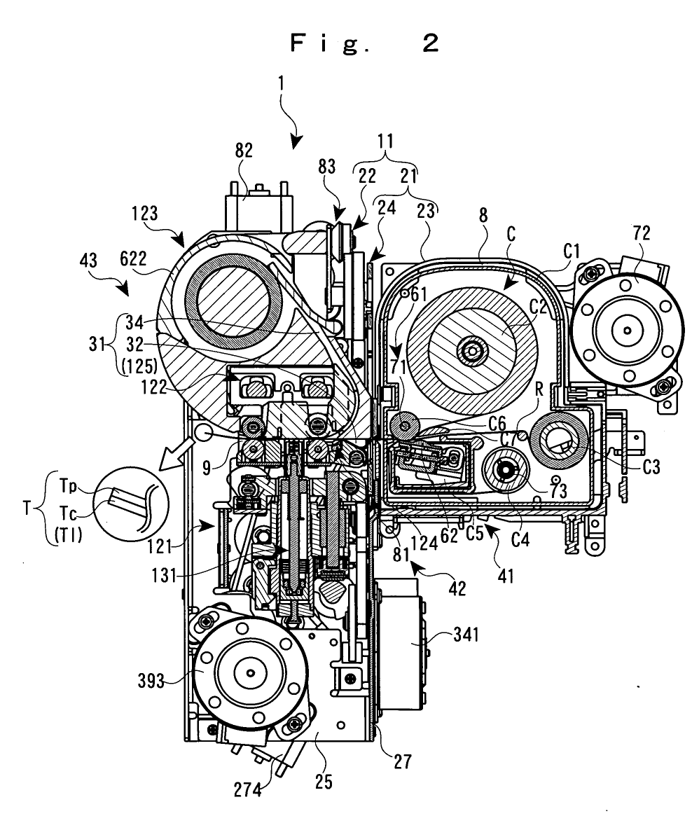

As shown in FIG. 2, a unitized apparatus assembly 11 is accommodated within the apparatus case 2. The apparatus assembly 11 is composed of a support frame 21 fixed to the apparatus case 2 and an internal device 22 built in the support frame 21. The support frame 21 is provided with a cartridge frame 23 which constitutes the cartridge mounting part 8 and a common support frame 24 attached thereto. The common support frame 24 has a lower frame 25 used as a bottom plate, an upper frame 26 which faces the lower frame 25, and a vertical frame 27 provided between the lower frame 25 and the upper frame 26 (see FIGS. 2, 3, and 5).

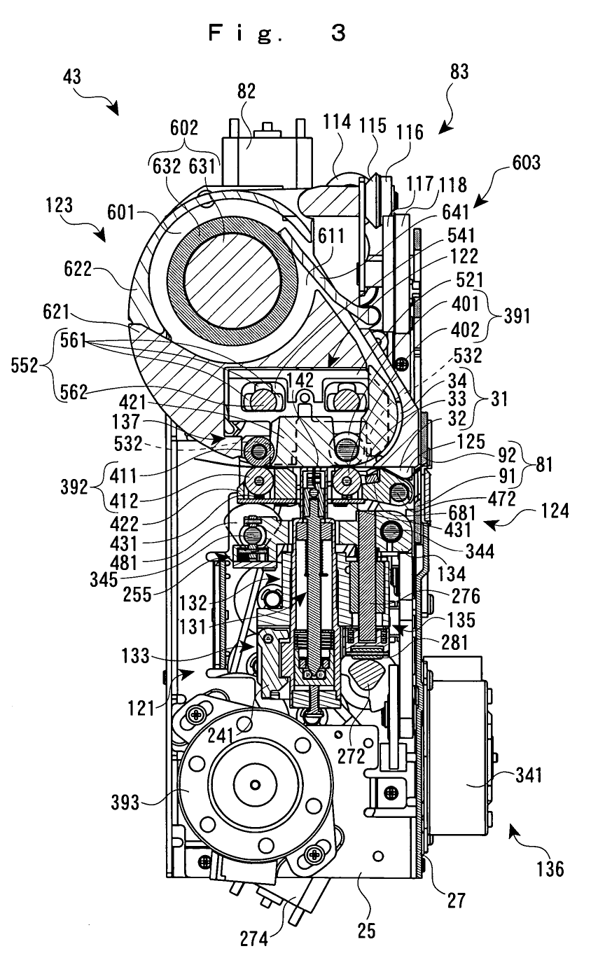

Moreover, as shown in FIGS. 2 and 3, a tape feed path 31 for feeding a processing tape T supplied from a tape cartridge C is formed by the support frame 21 and the apparatus case 2. The tape feed path 31 is composed of a first feed path 32 formed in a straight line from a tape supply slot (as will be described later) of the tape cartridge C to a tape ejecting slot 9 thereof and a second feed path 34 branching off from the middle of the first feed path 32 by a branching portion 33 and communicating with the tape accommodating section 601. In addition, reference numeral 125 shown in the figure is a tape buffer 125 used in some of the cutting processing (it will be described in detail).

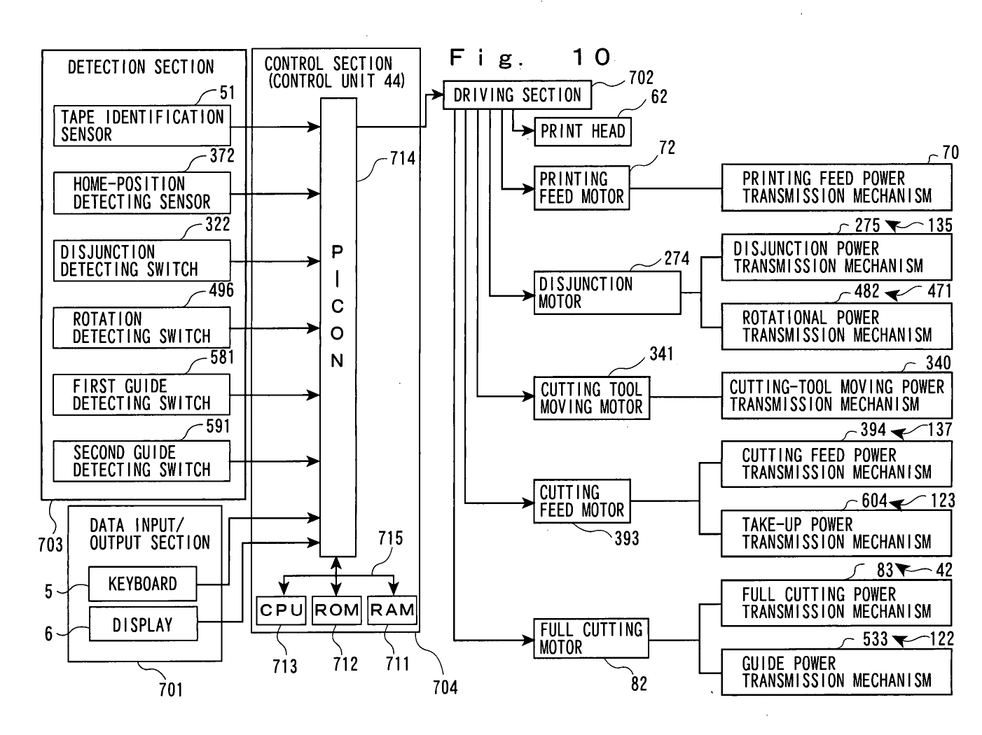

As shown in FIG. 2, the internal device 22 includes a printing unit 41 which is incorporated in the cartridge frame 23 to perform a printing processing on the processing tape T (tape Tc for separated characters), a full cutting unit 42 which is supported by the common support frame 24 disposed to face the tape feed path 31 and performs a full cutting process on the processing tape T, a cutting unit 43 which is located on the downstream side of the full cutting unit 42 and supported by the common support frame 24 and performs cutting processing on the processing tape T (tape Tc for separated characters), and a control unit 44, not in the figure, (see FIG. 10) which generally controls the respective units.

Also, in this tape processing apparatus 1, after the printing processing is performed on the processing tape T by using the printing unit 41 that is controlled by the control unit 44, full cutting processing and cutting processing are sequentially performed by using the full cutting unit 42 and the cutting unit 43 so that desired characters can be printed and tape strips clipped into a desired shape can be created. In addition, although it is natural, it is also possible to obtain tape strips on which cutting processing is not performed but only printing is performed by performing printing processing and full cutting processing, and it is also possible to obtain tape strips on which printing processing is not performed but only clipping is performed by performing full cutting processing and cutting processing.

In addition, as shown in FIG. 2, the whole tape cartridge C used for this tape processing apparatus 1 is covered with the cartridge case C1 and includes a tape reel C2 which wounds the processing tape T in the form of a roll, a ribbon supply reel C3 which wounds the ink ribbon R in the form of a roll, and a ribbon take-up reel C4 which winds up the supplied ink ribbon R. Moreover, a through opening C5 through which a print head 62, as will be described later, of the printing unit 41 is loosely inserted is formed in the tape cartridge C. A rotatable platen roller C6 is disposed so as to face the through opening C5, while a path member C7 is provided in proximity to the platen roller C6 so that the processing tape T supplied from the tape reel C2 is guided so as to face the through opening C5.

The processing tape T faces the through opening C5 along with the platen roller C6, and its leading edge is drawn out to the outside (tape feed path 31) of the tape cartridge C from the tape supply slot (not shown) formed near the through opening C5. After overlapping the processing tape T in the position of the through opening C5 together, the ink ribbon R goes around the through opening C5 and is wound by the ribbon take-up reel C4.

In addition, in the tape cartridge C, the platen roller C6 and the path member C7 cooperate with each other to prevent the edge of the processing tape T drawn out from the tape supply slot from entering the tape cartridge C. More specifically, the platen roller C6 is rotatably supported by an oval bearing (not shown) in a state of being loosely inserted through the cartridge case C1. If the supplied processing tape T is intended to be fed backward, (the peripheral surface of) the platen roller C6 abuts against the path member C7 while its axis slips, whereby the backward feed of the processing tape T is prevented.

The processing tape T accommodated in this tape cartridge C is a sheet for separated characters obtained by laminating a peelable tape Tp on a tape Tc (tape body) for separated characters which has an adhesive face and on which printing and clipping work is performed, and the processing tape is adapted such that the separated characters which are clipped after processing can be adhered to a part by using the adhesive face. Two or more types of tapes Tc for separated characters having different ground colors and widths (from 4 to 36 mm in width) are prepared for the tape cartridge C, and a plurality of identification holes (not shown) for identifying the tapes are provided on the back side of the tape cartridge C.

On the other hand, a tape identification sensor 51 (see FIG. 10) composed of a plurality of microswitches is disposed in the cartridge mounting part 8 (bottom plate). If a tape cartridge C is set in the cartridge mounting part 8, the type of processing tapes T (tapes Tc for separated characters) can be identified from the array (bit pattern) of the identification holes provided in the back side of the tape cartridge C.

In addition, instead of the tape Tc for separated characters, a tape cartridge C for labels which accommodates a processing tape T consisting of a tape Tl for labels and a peelable tape Tp is adapted to be set in the cartridge mounting part 8. After printing is performed on the processing tape T (tape Tl for labels) by the tape processing apparatus 1, the tape is cut so that tape strips which can be stuck as labels can also be obtained. Also, the tape identification sensor 51 can also detect whether the tape cartridge C for separated characters is mounted, or the tape cartridge C for creation of labels is mounted, i.e., the type of tapes accommodated in the tape cartridge C.

Next, the respective units constituting the internal device 22 will be described. The printing unit 41 performs a printing processing on the processing tape T. As shown in FIG. 2, the printing unit has a printing feed mechanism 61 and the print head 62. By the printing feed mechanism 61, printing is performed on the processing tape T by supplying and feeding (printing feed) the processing tape T from the tape cartridge C and driving the print head (thermal head) 62 in synchronization with this.

The printing feed mechanism 61 includes a platen roller C6 disposed in the tape cartridge C, a platen driving shaft 71 which rotates a platen roller C6, a printing feed motor 72 for rotating the platen driving shaft 71, and a printing feed power transmission mechanism 70 (see FIG. 10) which reduces and transmits the power of the printing feed motor 72 to the platen driving shaft 71 by a speed reducing gear train. The platen driving shaft 71 is erected in the cartridge mounting part 8 and engages with the platen roller C6 of the tape cartridge C set in the cartridge mounting part 8. If the printing feed motor 72 is driven, the platen roller C6 rotates by the platen driving shaft 71, and thereby the supply feed (printing feed) of the processing tape T inserted between the platen roller and the print head 62 is performed, and the (printed) processing tape T is delivered sequentially to the full cutting unit 42 and the cutting unit 43 along the above-mentioned tape feed path 31.

In addition, a ribbon take-up drive shaft 73 which engages with the above-described ribbon take-up reel C4 is erected in the cartridge mounting part 8 in the same manner as the platen driving shaft 71. The power of the printing feed motor 72 is also transmitted to the ribbon take-up drive shaft 73 by the printing feed power transmission mechanism 70, and the platen driving shaft 71 and the ribbon take-up drive shaft 73 rotate in synchronization with each other. That is, the feed of the processing tape T and the take-up of the ink ribbon R are performed synchronously.

The print head 62 is erected in the cartridge mounting part 8 in a state of being covered with a head cover (not shown). If the tape cartridge C is set in the cartridge mounting part 8, the print head 62 is loosely inserted through the through opening C5 of the tape cartridge C. Accordingly, the print head 62 faces the platen roller C6, with the processing tape T and the ink ribbon R located in the through opening C5 being interposed therebetween.

By a head release mechanism (not shown), the print head 62 is adapted to be brought into contact with or separated from the platen roller C6 in interlocking with opening and closing of the cartridge opening and closing lid 7. That is, if the cartridge opening and closing lid 7 is closed, the print head 62 abuts on the platen roller C6 (interposed) with the processing tape T and the ink ribbon R therebetween by the head release mechanism, which results in a state in which heat transfer (printing) to the tape Tc for separated characters of the processing tape T is allowed.

Next, the full cutting unit 42 will be described. As shown in FIGS. 2 and 3, the full cutting unit 42 adjoins the cartridge mounting part 8 and is disposed on the downstream side in the tape feed direction of the printing unit 41, i.e., between the printing unit 41 and the cutting unit 43. As shown in FIGS. 2 to 4, the full cutting unit 42 includes a full cutter 81 which is supported by the vertical frame 27, faces the tape feed path 31 (first feed path), and cuts the processing tape T, which has been fed from the printing unit 41, in a scissors form, a full cutting motor 82 which constitutes a power source for allowing the full cutter 81 to perform a cutting operation, and a full cutting power transmission mechanism 83 which transmits the power of the full cutting motor 82 to the full cutter 81, to allow the full cutter to perform a cutting operation (full cutting processing).

As shown in FIG. 3, the full cutter 81 is composed of a stationary blade 91 fixed to the vertical frame 27, and a movable blade 92 rotatably supported by the stationary blade 91 by a pivot (not shown). Also, the full cutter rotates (rocks) the movable blade 92 about the pivot to cut the processing tape T (full cutting).

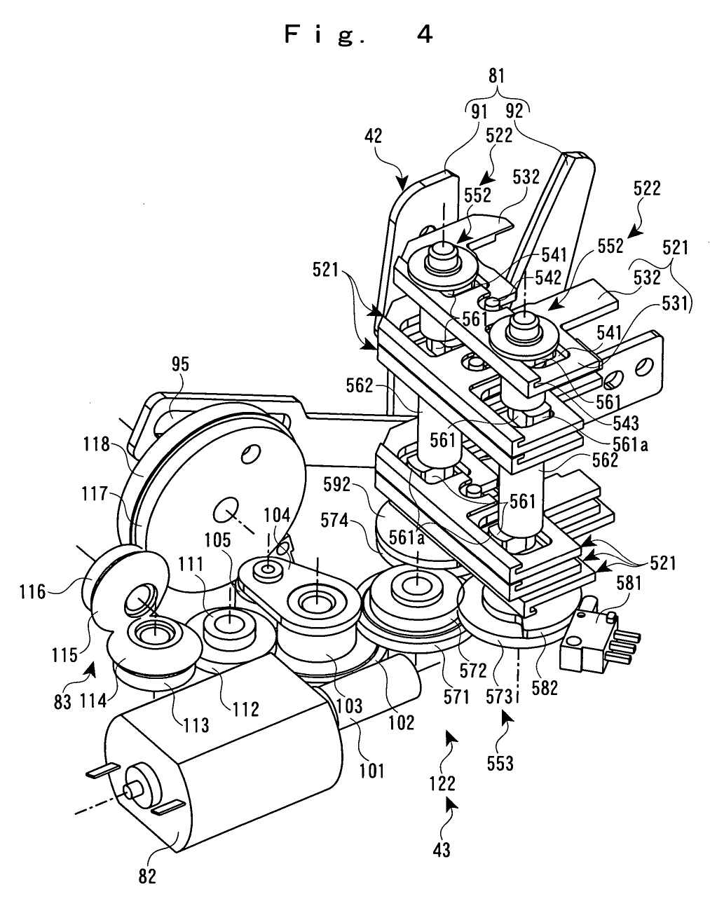

The full cutting motor 82 includes DC motors. The power of the full cutting motor 82 serves as a driving source of the below-mentioned width guide mechanism 122. By clutch changeover, the rotational power in any one of forward and backward directions drives the full cutting unit 42, and the rotational power in the other direction drives the width guide mechanism 122 (see FIG. 4).

As shown in FIG. 4, the full cutting power transmission mechanism 83 has a full cutting worm 101 fixed to the output shaft of the full cutting motor 82, a full cutting worm wheel 102 which meshes with the full cutting worm 101, a full cutting first gear 103 fixed on the same axis as the full cutting worm wheel 102, a full cutting carrier 104 rotatably supported by a gear shaft of the full cutting first gear 103, a full cutting transmission gear 105 which is rotatably supported to a tip portion of the full cutting carrier 104 and meshes with the full cutting first gear 103, a full cutting second gear 111 adapted to be engageable with the full cutting transmission gear 105, a full cutting third gear 112 fixed on the same axis of the full cutting second gear 111, a full cutting fourth gear 113 which meshes with the full cutting third gear 112, a full cutting first bevel gear 114 fixed on the same axis as the full cutting fourth gear 113, a full cutting second bevel gear 115 which meshes with the full cutting first bevel gear 114, a full cutting fifth bevel gear 116 fixed on the same axis as the full cutting second bevel gear 115, and a full cutter driving gear 117 which meshes with the full cutting fifth bevel gear 116. Moreover, a full cutting crank wheel 118 having almost the same diameter as the full cutter driving gear is fixed to the full cutter driving gear 117 on the same axis as the full cutter driving gear, and a crank pin (not shown) which engages with a long hole 95 formed in the movable blade 92 is provided in the full cutting crank wheel 118.

Also, if the full cutting motor 82 rotates in a predetermined direction (forward direction), power is transmitted in the order of the full cutting worm 101, the full cutting worm wheel 102, the full cutting first gear 103, and the full cutting transmission gear 105. At this time, the full cutting carrier 104 rotates together with the rotation of the full cutting first gear 103, and the full cutting transmission gear 105 meshes with the full cutting second gear 111. Accordingly, power is transmitted to the full cutter driving gear 117 (power is not transmitted to the width guide mechanism 122), to rotate the full cutting crank wheel 118. As a result, the rotation of the full cutter driving gear 117 is transmitted to the movable blade 92 by the crank pin to rock the movable blade 92, so that a slitting operation is performed on the processing tape T (rocking crank mechanism).

In addition, although not shown, a microswitch is attached to the peripheral surface of the full cutting crank wheel 118, and the home position of the full cutter 81 can be detected as a switch end of the microswitch falls in a recess formed in one place of the peripheral surface of the full cutting crank wheel 118.

Next, the cutting unit 43 will be described. The cutting unit 43 performs cutting processing which cuts only the tape Tc for separated characters (strictly including a portion of the peelable tape) of the processing tape T (tape strip) fed by the full cutting unit 42. In addition, in this case, the cutting processing includes the concept of the so-called half-cutting processing that cuts only the tape Tc for separated characters so as to transverse the tape width direction of the processing tape T (details thereof will be described later).

As shown in FIGS. 2 and 3, the cutting unit 43 includes a cutting mechanism 121 which is disposed to face the first feed path 32 and performs the cutting processing by the cutting tool 142 while a sheet for separated characters is fed forward and backward along the tape feed path 31, a width guide mechanism 122 which is disposed to face the cutting mechanism 121 (back and forth) with the first feed path 32 inserted therebetween and guides the processing tape T facing the tape feed path 31 in a tape width direction for the cutting processing, a tape accommodating mechanism 123 which has the tape accommodating section 601 connected to the second feed path 34 and which operates so as to wind in a trailing end of the cut processing tape T which is fed forward and backward by the cutting processing, a path change mechanism 124 (guide mechanism) for guiding the trailing end of the processing tape T on which full cutting has been performed, to the second feed path 34 for cutting processing, and a tape buffer 125 which faces the first feed path 32 and is provided adjacent to the downstream side of the full cutter 81 and performs cutting processing on a non-cut processing tape T.

As shown in FIG. 3 and FIGS. 5 to 8, the cutting mechanism 121 includes a cutting tool unit 131 including a cutting tool 142 as the entity of cutting processing and performs slitting on the processing tape T (tape Tc for separated characters), a tool holder 132 which removably holds the cutting tool unit 131, a cutting tool attachment/detachment mechanism 133 (cutting tool locking mechanism) for attaching and detaching the cutting tool unit 131 to and from the tool holder 132, a cutting tool carriage 134 which movably supports the cutting tool unit 131 by means of the tool holder 132 in the tape width direction (that is, vertical direction) of the processing tape T orthogonal to the tape feed direction, a cutting tool disjunction mechanism 135 which brings the cutting tool 142 into contact with the processing tape T and separates the cutting tool from the processing tape T by means of the tool holder 132, a cutting tool moving mechanism 136 for moving the cutting tool carriage 134 forward and backward in the tape width direction, and a cutting feed mechanism 137 which feeds the processing tape T fed into the cutting unit 43 by the above-mentioned printing feed mechanism 61 forward and backward along the tape feed path 31. Moreover, a blade edge direction setting mechanism 138 is provided in the cutting feed mechanism 137 so as to set the direction of a cutting edge of the cutting tool 142, which faces the below-mentioned movement start position, to a predetermined direction.

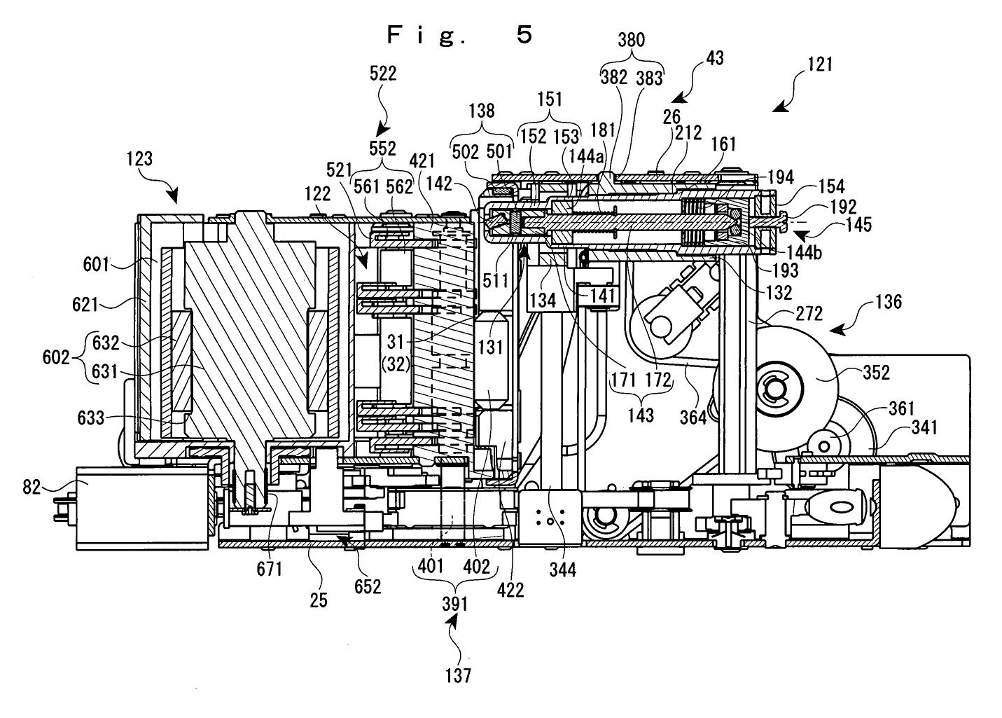

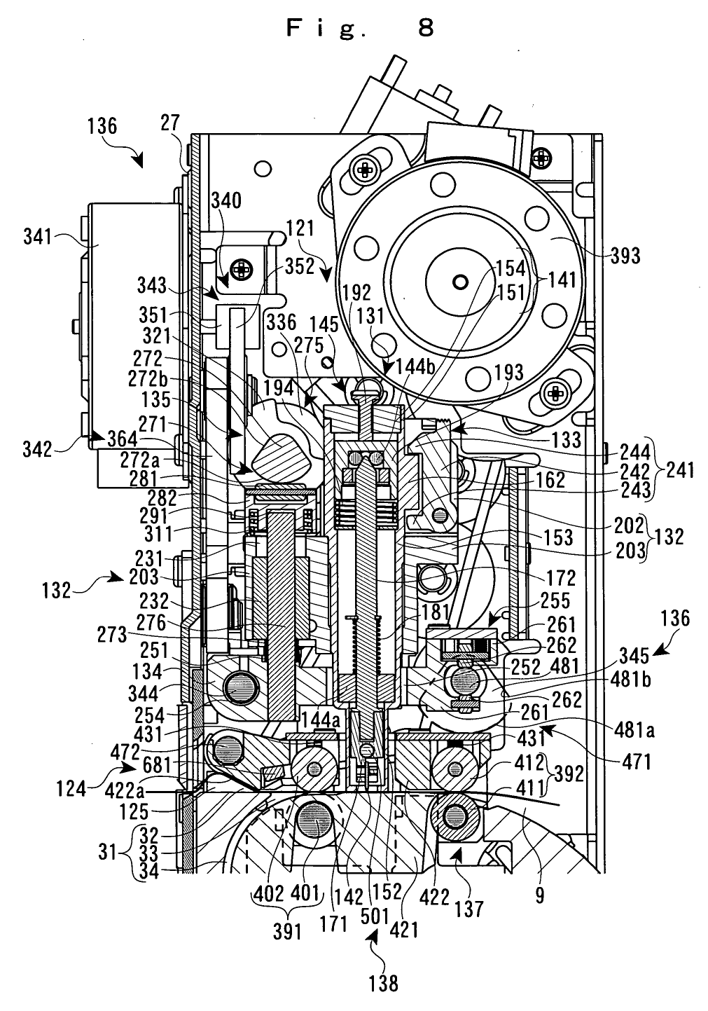

As shown in FIGS. 5 to 8, the cutting tool unit 131 has a substantially cylindrical cutting tool cover 141 which forms the outer shell of the cutting tool unit 131, the cutting tool 142 whose cutting edge protrudes slightly by a predetermined amount from the leading edge of the cutting tool cover 141 which becomes the tape feed path side, a cutting tool holding member 143 which holds the cutting tool 142 at its tip portion, a pair of bearings 144a and 144b which rotatably journal the cutting tool holding member 143, and a cutting tool adjustment mechanism 145 for adjusting the protruding amount (depth of cut of the cutting tool 142 with respect to the processing tape T) (of cutting edge) of the cutting tool 142 which projects from the cutting tool cover 141. In addition, in the above-mentioned vertical frame 27 which constitutes the tape feed path 31, the portion which faces the cutting tool 142 is formed flatly, and this flat portion functions as a cutting tool receiving face for the cutting tool 142 which performs a slitting operation (see FIGS. 5 and 8).

As shown in FIGS. 5 and 8, the cutting tool cover 141 is composed of a cylindrical cover portion 151 having a tip-side smaller diameter part 152, which is positioned on the side of the tape feed path surrounds the cutting tool 142 and a base-side larger diameter part 153 connected to the smaller diameter part 152 and having a diameter larger than the smaller diameter part, and a lid cover portion 154 which blocks up the base side of the cylindrical cover portion 151 (larger diameter part 153).

A end face of the smaller diameter part 152 is flatly formed while it has a projection slot (not shown) for the cutting tool 142, and the end face pushes the processing tape T toward the cutting tool receiving face so as to prevent the processing tape T from floating due to the cut resistance of the processing tape T accompanying cutting processing. The larger diameter part 153 is formed in a gentle tapered shape toward the tip so that the tool holder 132 can mount the cutting tool unit 131 without rattling. Moreover, a stepped part 161 used as a stopper when the cutting tool unit 131 is mounted on the tool holder 132 is formed in the larger diameter part 153. Moreover, the portion of the tool holder 132 which faces the stepped part 161 of the larger diameter part 153 and is located closer to the tip than the stepped part 161 is partially cut-away. A protruding part 162 which protrudes diametrically is formed on this cut-away part of the part of the cylindrical cover portion 151. The protruding part 162 functions as a guide when the cutting tool unit 131 is mounted on the tool holder 132 and becomes a locking part for fixing the cutting tool unit 131 to the tool holder 132 (details thereof will be described later).

As shown in FIGS. 5 and 8, the cutting tool holding member 143 is composed of a cylindrical cutting tool holding block 171 which holds the cutting tool 142 at the tip portion and is loosely inserted through the smaller diameter part 152 and a cutting tool holding shaft 172 at the tip portion of which the cutting tool holding block 171 is fit and fixed and which is rotatably supported to a pair of bearings 144a and 144b. The cutting tool 142 held by the cutting tool holding block 171 is composed of an inclined blade and is offset from the position of the cutting edge thereof and the rotational axis of the cutting tool holding shaft 172. Therefore, the cutting tool holding shaft 172 rotates according to the direction of the cut resistance that the cutting tool 142 receives by cutting processing, and the direction of the blade edge of the cutting tool 142 turns to the slitting direction of the processing tape T. In addition, reference numeral 501 in the figure denotes a cutting-tool-side magnet of the blade edge direction setting mechanism 138 as will be described later.

Each of the bearings 144a and 144b is composed of a ball bearing. As shown in FIGS. 5 and 8, one radial bearing 144a of a pair of bearing members is disposed at the tip portion of the larger diameter part 153, and the other angular bearing 144b thereof is incorporated in a slide member 193 (as will be described later) which constitutes the cutting tool adjustment mechanism 145.

In addition, the cutting tool unit 131 is provided with a compression spring 181 whose one end abuts against the radial bearing 144a and whose other end abuts against a pin which penetrates the cutting tool holding shaft 172. The compression spring pulls up the cutting tool 142 toward the rear end of the cutting tool unit 131 (cutting tool holding shaft 172) through the cutting tool holding shaft 172.

As shown in FIGS. 5 and 8, the cutting tool adjustment mechanism 145 includes an adjusting screw 192 screwed to the axial center of the lid cover portion 154 from the outside, a slide member 193 which is adapted to be slidable on an inner peripheral surface of the larger diameter part 153 and against which the tip of the adjusting screw 192 is butted, and a biasing spring 194 which is interposed between an inside stepped part of the larger diameter part 153 and the slide member 193 and biases the slide member 193 toward the adjusting screw 192. If the adjusting screw 192 is adjusted rotationally, the cutting tool holding shaft 172 slides (advances or retreats) in an axis direction through the slide member 193 by the prismatic pair of the adjusting screw. Accordingly, the protruding amount of the cutting tool 142 connected with the cutting tool holding shaft 172 from the cutting tool cover 141 can be changed, and the depth of cut of the cutting tool 142 at the time of cutting processing can be adjusted as required.

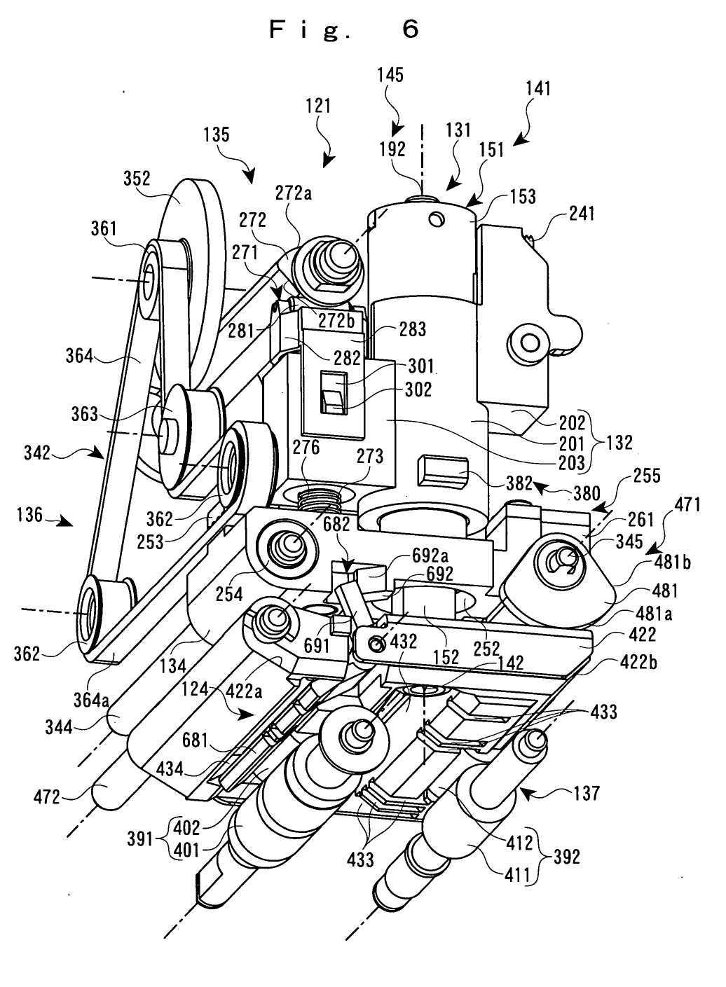

As shown in FIGS. 6 to 8, the tool holder 132 includes a substantially cylindrical unit mounting part 201 on which the cutting tool unit 131 is mounted, an attachment/detachment guide part 202 which is fixed to the unit mounting part 201 and guides the attachment and detachment of the cutting tool unit 131 to the unit mounting part 201, and a cutting tool supporting part 203 which is supported by the cutting tool carriage 134 while supporting the unit mounting part 201. In addition, the unit mounting part 201, the attachment/detachment guide part 202, and the cutting tool supporting part 203 are formed integrally with one another from resin, etc.

The unit mounting part 201 mounts the cutting tool unit 131 and has a mounting through-opening (not shown) for attaching and detaching or holding the cutting tool unit 131 horizontally (parallel) so that the cutting tool unit 131 (cutting tool 142) becomes perpendicular to the tape feed path 31 (first feed path 32), i.e., the processing tape T. Moreover, the mounting through-opening (on the side of the cutting tool supporting part 203) is provided with an insertion position regulating part 212 which receives (engages with) the stepped part 161 formed in the cylindrical cover portion 151 and regulates the insertion position of the cutting tool 131 in the attachment/detachment directions of the cutting tool 131.

In addition, as shown in FIGS. 5 and 6, a locking projection 382 for locking the tool holder 132 in the common support frame 24 (upper frame 26) at the time of replacement of the cutting tool unit 131 is provided on the unit mounting part 201 so as to protrude therefrom (details thereof will be described later).

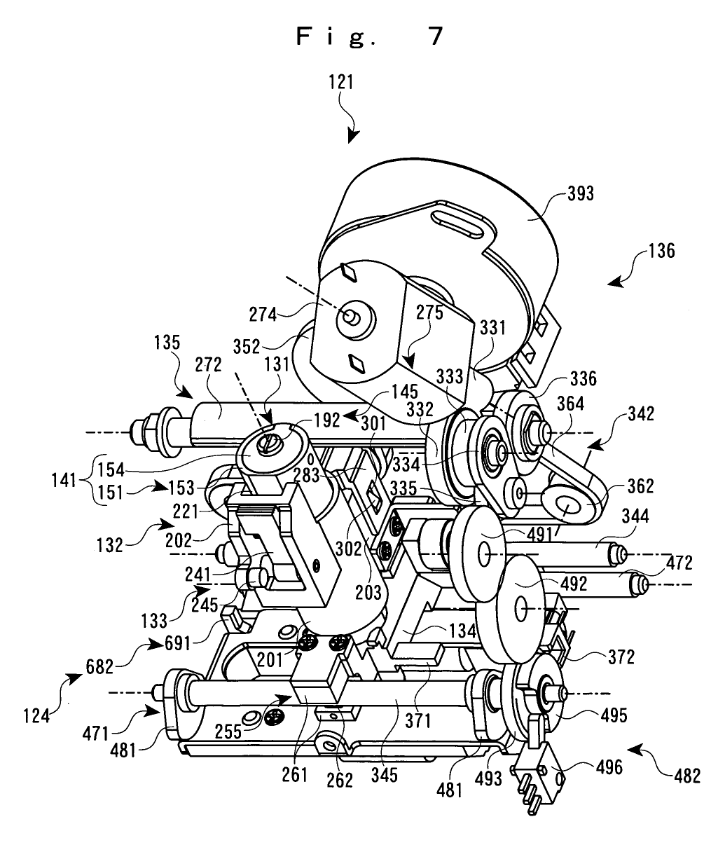

The attachment/detachment guide part 202 extends in the attachment/detachment directions of the cutting tool unit 131 (from the unit mounting part 201) and has a recessed part 221 (see FIG. 7) formed in a shape complementary to the protruding part 162 (see FIG. 8) formed in the cylindrical cover portion 151. Therefore, when the cutting tool unit 131 is mounted in the mounting through-opening, by making the protruding part 162 engage with the recessed part 221, it is possible to mount the cutting tool unit 131 at a predetermined angle around the axis by using the protruding part as a guide. Moreover, an opening (not shown) formed so as to be connected to the recessed part 221 is provided in the attachment/detachment guide part 202, and the above-mentioned cutting tool attachment/detachment mechanism 133 is incorporated in this opening so as to face it.

As shown in FIGS. 6 and 8, the cutting tool supporting part 203 is formed substantially in the shape of a rectangular parallelepipe and supports the cutting tool unit 131 by the unit mounting part 201. On the other hand, the cutting tool supporting part 203 is supported by the cutting tool carriage 134 by the disjunction guide shaft 276 (as will be described later). Moreover, the cutting tool supporting part is adapted to be movable by the linear bush 232 supported to the disjunction guide shaft 276 in the cutting tool disjunction direction which is the same direction as the attachment/detachment direction the cutting tool 142. That is, the cutting tool supporting part 203 is provided with a guide insertion opening 231 which allows the disjunction guide shaft 276 (as will be described later) protruding vertically with respect to the tape feed path 31 from the cutting tool carriage 134 to be inserted therethrough. Also, this guide insertion opening 231 is provided with a linear bush 232 (bearing) which guides movement of the cutting tool supporting part 203 in the cutting tool disjunction direction in cooperation with the disjunction guide shaft 276. Moreover, a guide disjunction spring (return spring) 273 as will be described later is interposed between the cutting tool carriage 134 and the cutting tool supporting part 203 so as to wind around the disjunction shaft 276.

The cutting tool attachment/detachment mechanism 133 is incorporated in the attachment/detachment guide part 202 of the tool holder 132 and locks the cutting tool unit 131 in the tool holder 132 and unlocks it from the tool holder. As shown in FIGS. 7 and 8, the cutting tool attachment/detachment mechanism 133 includes a cutting tool detaching lever 241 which is disposed to face the opening of the attachment/detachment guide part 202 and which is rotatably supported to the attachment/detachment guide part 202 between a cutting tool mounting position where the cutting tool unit 131 is mounted and fixed and a cutting tool detachment position where the cutting tool unit 131 is detached, and a lever biasing member which biases the cutting tool detaching lever 241 toward the cutting tool mounting position (not shown)

As shown in FIG. 8, the cutting tool detaching lever 241 is formed substantially in the shape of the letter “U” in plan view. A lever body 242 rotatably supported to the attachment/detachment guide part 202 so as to be parallel to a moving direction of the cutting tool carriage 134, a spring-up piece 243 provided on the base side of the lever body 242 so as to protrude toward the cutting tool unit 131 in the cutting tool mounting position, and a locking piece 244 provided on the side of a rotating end of the lever body 242 so as to protrude toward the cutting tool unit 131 in the cutting tool mounting position are integrally formed with one another.

In this embodiment, the lever energizing member is composed of a torsion coil spring (not shown), and the spring receptacle 245 for allowing the torsion coil spring to be disposed therein is provided in the attachment/detachment guide part 202 (see FIG. 7).

Here, an attachment/detachment method of the cutting tool unit 131 will be described. In a case where the cutting tool unit 131 is mounted, with the cutting tool detaching lever 241 in the cutting tool detachment position, the cutting tool unit 131 is first provisionally mounted in the mounting through-opening, and thereafter the cutting tool detaching lever 241 is rotated to the cutting tool mounting position. Accordingly, the end face (face opposite to the tape feed path) of the protruding part 162 of the cutting tool unit 131 abuts against the locking piece 244. With the position of the cutting tool unit 131 in the attachment/detachment direction being regulated by the locking piece 244, the cutting tool unit 131 is mounted in and fixed to the mounting through-opening (locked state). In this case, a gap exists between the spring-up piece 243 and the protruding part 162 (see FIG. 8).

On the other hand, when the cutting tool unit 131 mounted in the mounting through-opening is detached, the cutting tool detaching lever 241 is rotated between cutting tool detachment positions against the lever energizing member. Accordingly, the locking piece 244 is disengaged from the end face of the protruding part 162, thereby releasing the fixation of the cutting tool unit 131 in the mounting through-opening, and the end face (face on the side of the tape feed path) of the protruding part 162 is sprung up by the spring-up piece 243, and thereby the cutting tool unit 131 is slightly drawn out from the mounting through-opening, which results in a detachable state (unlocked state).

Next, the cutting tool carriage 134 will be described. As shown in FIGS. 6 to 8, the block-like cutting tool carriage 134 supports the tool holder 132 (cutting tool supporting part 203), with the disjunction spring 273 of the cutting tool disjunction mechanism 135 being interposed therebetween. The cutting tool carriage also has a spring receptacle part 251 which receives the disjunction spring 273, a cutting tool loose-fit opening 252 for making (the cutting tool 142 of) the tape feed path 31 face the cutting tool unit 131 supported by the cutting tool carriage 134 by the tool holder 132, a belt fixing part 253 fixed to a cutting tool movement timing belt 364 (as will be described later) of the cutting tool moving mechanism 136, and carriage guides 254 and 255 for guiding movement of the cutting tool carriage 134 in the tape width direction by the cutting tool moving mechanism 136.

In addition, as shown in FIG. 8, a disjunction guide shaft 276 (as will be described later) which constitutes the cutting tool disjunction mechanism 135 is provided on the cutting tool carriage 134 so as to protrude therefrom, and the tool holder 132 is supported by the cutting tool carriage 134 by this disjunction guide shaft 276. Moreover, reference numeral 371 of FIG. 7 denotes a home position detecting piece for detecting the home position of the cutting tool 142 on the basis of the position of the cutting tool carriage 134, and reference numeral 692 of FIG. 6 denotes an actuating piece of the path change mechanism 124 (all will be described later). These detecting piece and actuating piece are integrally formed with the cutting tool carriage 134.

As shown in FIG. 6, the cutting tool loose-fit opening 252 is provided in an almost intermediate position of the cutting tool carriage 134 in the tape feed direction and the tape width direction. The smaller diameter part 152 of the cutting tool unit 131 is loosely inserted through this cutting tool loose-fit opening and is allowed to protrude toward the tape feed path. The belt fixing part 253 is an upstream end of the cutting tool carriage 134 in the tape feed direction and is provided in almost the intermediate position in the tape width direction.

The carriage guides 254 and 255 are composed of a pair of guides spaced apart in the tape feed direction so as to sandwich the cutting tool loose-fit opening 252 therebetween. Specifically, the carriage guides includes a first carriage guide 254 which is disposed on the upstream side in the tape feed direction and guided by the below-mentioned first carriage guide shaft 344, and a second carriage guide 255 which is disposed on the downstream side in the tape feed direction, engages with the below-mentioned second carriage guide shaft 345, and guides movement of the cutting tool carriage 134 along with the first carriage guide 254. As described above, in this embodiment, the movement of the cutting tool carriage 134 by the cutting tool moving mechanism 136 can be stably guided by configuring the carriage guides 254 and 255 with a pair of guides being disposed so that they can be brought into contact with or separated from each other.

As shown in FIGS. 6 and 8, the first carriage guide 254 is composed of a linear bush which allows the first carriage guide shaft 344 to be inserted through the cutting tool carriage 134 and which slidably engages with the first carriage guide shaft 344. As shown in FIGS. 6 to 8, the second carriage guide 255 has a pair of carriage guide pieces 261 which protrude toward the downstream side in the tape feed direction from the cutting tool carriage 134 so as to hold the second carriage guide shaft 345 therebetween. Guide rolling-contact rollers 262 which come into rolling contact with the second carriage guide shaft 345 are provided in the carriage guide pieces 261, respectively. The guide rollinq-contact roller 262 is rotatably supported to the carriage guide piece 261 so that its axis line intersects the axis line of the second carriage guide shaft 345 at right angles to each other, and the second carriage guide shaft 345 is interposed between a pair of these guide rolling-contact rollers 262 (see FIG. 8). Also, at the time of movement of the cutting tool carriage 134 by the cutting tool moving mechanism 136, since the second carriage guide shaft 345 is rolled and the movement of the cutting tool carriage 134 is guided while the pair of guide rolling-contact rollers 262 rotate, the sliding resistance of the second carriage guide 255 against the second carriage guide shaft 345 can be reduced.

The cutting tool disjunction mechanism 135 moves the tool holder 132 (horizontally) in the cutting tool disjunction direction orthogonal to the tape feed path 31 (first feed path 32), to thereby vertically move the cutting tool 142 with respect to the processing tape T (move the cutting tool 142 up and down). Specifically, the cutting tool disjunction mechanism moves the cutting tool 142 to bring the cutting tool 142 into contact with the processing tape T or separate it from the processing tape between a position on the side of the tape feed path 31, that is, a slitting position where slitting of the processing tape T is allowed, and a position spaced (by a predetermined distance) from the processing tape T.

As shown in FIGS. 6 and 8, the cutting tool disjunction mechanism 135 includes a pressing member 271 fixed to the tool holder 132, a disjunction cam shaft 272, having a plate-cam-shaped cross-section, which extends in the tape width direction that is the direction of movement of the cutting tool carriage 134 and moves the tool holder 132 in the cutting tool disjunction direction by the pressing member 271, a disjunction spring 273 which biases the tool holder 132 toward the disjunction cam shaft 272 by the pressing member 271 and has a function as a return spring, a disjunction motor 274 used as a rotation power source of the disjunction cam shaft 272, a disjunction power transmission mechanism 275 which transmits the power of the disjunction motor 274 to the disjunction cam shaft 272, and a fixed disjunction guide shaft 276 which guides movement of the tool holder 132 to the cutting tool carriage 134 while supporting the tool holder 132 to make the supported tool holder supported by the cutting tool carriage 134.

The pressing member 271 is attached to the end face of the cutting tool supporting part 203 (non-slitting position side) opposite to the tape feed path in the cutting tool disjunction direction. The pressing member has a cam shaft rolling-contact roller 281 which comes into rolling contact with the disjunction cam shaft 272, a roller supporting member 282 which supports the cam shaft rolling-contact roller 281, and a pair of hooking pieces 283 which extend toward the tape feed path 31 from the roller supporting member 282 and is hooked so as to hold both side surfaces of the cutting tool supporting part 203 therebetween.

As shown in FIG. 8, the cam shaft rolling-contact roller 281 is located on the axis line of the disjunction guide shaft 276, and the roller is rotatably supported to the roller supporting member 282 so that the axis line of the disjunction cam shaft 272 intersect the axis line of the cam shaft rolling-contact roller 281 at right angles to each other. The roller supporting member 282 rotatably journals the cam shaft rolling-contact roller 281 so as to protrude toward the side opposite to the tape feed path. Moreover, a guide insertion recess 291 which allows the tip portion of the disjunction guide shaft 276 inserted through the cutting tool supporting part 203 to be inserted therethrough is formed at the end face of the roller supporting member (facing the cam shaft rolling-contact roller 281) 282 on the side of the tape feed path (slitting position side), so that the movement of the roller supporting member 282 in the cutting tool disjunction direction is also guided by the end of the disjunction guide shaft 276. A hooking opening 301 is formed in each hooking piece 283, so that the hooking opening 301 is locked by a hooking pawl 302 formed to protrude from each side face of the cutting tool supporting part 203 hooked by the hooking piece 283 (see FIGS. 6 and 7). That is, the pressing member 271 is detachably mounted on the cutting tool supporting part 203.

In addition, as shown in FIG. 8, the load adjusting spring 311 for adjusting the slitting load (pressure) of the cutting tool 142 to the processing tape T is provided within the roller supporting member 282 (slitting position side). Also, this load adjusting spring 311 biases the cutting tool supporting part 203 toward the slitting position with a predetermined biasing force, to thereby bias the cutting tool 142 toward the slitting position with a predetermined biasing force, so that the slitting load of the cutting tool 142 is adjusted to a predetermined value, and a slight gap exists between the roller supporting member 282 and the cutting tool supporting part 203. Moreover, if the slitting load is applied to the cutting tool 142 beyond a predetermined value, the cutting tool supporting part 203 moves toward the non-slitting position against the load adjusting spring 311, so that the cutting tool 142 retreats toward the non-slitting position. Accordingly, even if the cutting tool 142 rides on a certain obstacle, the damage to the surrounding area of the cutting tool 142 is prevented.

As shown in FIGS. 6 to 8, the disjunction cam shaft 272 is a rod-shaped cam which has a substantially fan-shaped cam profile in a cross-section view, and the cam shaft is rotatably supported to the lower frame 25 and the upper frame 26 while it is eccentric. Also, as the side face of the disjunction cam shaft 272 pushes the tool holder 132 (cutting tool supporting part 203) by the pressing member 271 (cam shaft rolling-contact roller 281), the cutting tool 142 moves between the slitting position and the non-slitting position.

Specifically, when an arc-shaped part 272a of the disjunction cam shaft 272 abuts against the cam shaft rolling-contact roller 281 by the rotation of the disjunction cam shaft 272, the cutting tool 142 moves to the slitting position. On the other hand, if one radial part 272b the disjunction cam shaft 272 abuts against to the cam shaft rolling-contact roller 281, the cutting tool 142 moves to the non-slitting position. That is, a cam mechanism is formed by using the disjunction cam shaft 272 as a cam and using the cam shaft rolling-contact roller 281 as a follower. This cam mechanism positively transforms a rotary motion of the disjunction cam shaft 272 to the movement of the cutting tool 142 between the slitting position and the non-slitting position in cooperation with the disjunction spring 273.

Moreover, since the disjunction cam shaft 272 extends in the moving direction of the cutting tool carriage 134 and is provided over the range of movement of the cutting tool carriage 134, even if the cutting tool carriage 134 faces any position by the cutting tool moving mechanism 136, the tool holder 132 can be pushed by the pressing member 271 (cam shaft rolling-contact roller 281), so that the cutting tool 142 is movable to either the slitting position or the non-slitting position. Also, in a case where the cutting tool carriage 134 is moved by the cutting tool moving mechanism 136, since the cam shaft rolling-contact roller 281 comes into rolling contact with the disjunction cam shaft 272, it is possible to reduce the sliding resistance between the disjunction cam shaft 272 and the pressing member 271 at the time of the movement of the cutting tool carriage 134.

In addition, a disjunction detecting cam 321 is fixed to the base side (that is, the lower frame 25 side) of the disjunction cam shaft 272. If the disjunction cam shaft 272 rotates, the disjunction detecting cam 321 also rotates with this. Moreover, a disjunction detecting switch 322 (see FIG. 10) turned on and off by the disjunction detecting cam 321 is provided in the lower frame 25. Also, when the disjunction detecting cam 321 and the disjunction detecting switch 322 cooperate with each other, the rotation amount of the disjunction cam shaft 272 is detected, to thereby make it possible to grasp whether or not the cutting tool 142 shall be located in any one of the slitting position and the non-slitting position.

A disjunction spring 273 is interposed between the cutting tool carriage 134 and the tool holder 132 (cutting tool supporting part 203) to bias the tool holder 132 toward the non-slitting position (see FIGS. 6 and 8). Accordingly, the cam shaft rolling-contact roller 281 of the pressing member 271 fixed to the cutting tool supporting part 203 will be in a state where the cam shaft rolling-contact roller always abuts against the disjunction cam shaft 272, so that the rotary motion of the disjunction cam shaft 272 can be positively transformed to the movement of a cutting tool 142.

The disjunction motor 274 is composed of a reversible DC motor and is supported by the common support frame 24. As shown in FIG. 7, the disjunction power transmission mechanism 275 has a disjunction worm 331 fixed to an output shaft of the disjunction motor 274, a disjunction worm wheel 332 which meshes with the disjunction worm 331, a disjunction first gear 333 fixed on the same axis as the disjunction worm wheel 332, a disjunction carrier 334 rotatably supported to a gear shaft of the disjunction first gear 333, a disjunction transmission gear 335 which is rotatably supported to the disjunction carrier 334 and meshes with the disjunction first gear 333, and a disjunction cam drive gear 336 which is adapted to be meshed with the disjunction transmission gear 335 and is fixed to a base (lower frame 25 side) of the disjunction cam shaft 272. If the disjunction motor 274 is rotated in one predetermined direction (for example, forward direction), the rotational power is transmitted to the disjunction worm 331, the disjunction worm wheel 332, and the disjunction first gear 333. Also, by the disjunction carrier 334 which rotates together with the disjunction first gear 333, the disjunction transmission gear 335 meshes with the disjunction cam drive gear 336, and the disjunction cam shaft 272 rotates.

In addition, the disjunction motor 274 serves as a power source of the below-mentioned roller disjunction mechanism 471. Also, the disjunction carrier 334 and the disjunction transmission gear 335 compose the one-way clutch. The rotation of the disjunction motor 274 in one direction (for example, forward direction) is used as the power for the cutting tool disjunction mechanism 135, and the rotation thereof in the other direction (for example, reverse direction) is used as the power for the roller disjunction mechanism 471.

As shown in FIG. 8, the disjunction guide shaft 276 has its base press-fitted and fixed to the cutting tool carriage 134 and extends in the cutting tool disjunction direction toward the disjunction cam shaft 272 from the cutting tool carriage 134. Also, the disjunction guide shaft 276 is inserted through the guide insertion opening 231 of the cutting tool supporting part 203 and the guide insertion recess 291 of the roller supporting member 282, which are mentioned above. Also, the disjunction guide shaft supports the tool holder 132 by the cutting tool supporting part 203 and guides the movement of the cutting tool supporting part 203 and the roller supporting member 282 which are transformed from the rotary motion of the disjunction cam shaft 272.

In this case, the rotational axes of the cam shaft rolling-contact roller 281 and the disjunction cam shaft 272 are located on the axis line of the disjunction guide shaft 276, so that the pressing force of the disjunction cam shaft 272 can be exerted on the axis line of the disjunction guide shaft 276. Therefore, the movement of the cutting tool supporting part 203 and the roller supporting member 282 can be securely guided, and the cutting tool 142 can be moved stably with its vertical posture with respect to the processing tape T being kept, without rattling the cutting tool 142 at the time of contact and separation thereof. In addition, as shown in FIG. 8, the linear bush 232 (ball spline) which engages with the disjunction guide shaft 276 is fixed to the guide insertion opening 231. By a rotary motion of this disjunction cam shaft 272, the cutting tool supporting part 203 moves very smoothly.

Here, a series of operations of the cutting tool disjunction mechanism 135 will be described. When the cutting tool 142 at the non-slitting position is moved to the slitting position, the disjunction motor 274 rotates in one predetermined direction, and the power is transmitted to the disjunction cam shaft 272 by the disjunction power transmission mechanism 275. Accordingly, the disjunction cam shaft 272 rotates, the tool holder 132 moves toward the tape feed path in a state where it has been guided to the disjunction guide shaft 276, and the cutting tool 142 moves toward the slitting position from the non-slitting position. Also, the disjunction motor 274 is driven by the cooperation of the disjunction detecting cam 321 and the disjunction detecting switch 322 until the abutment of the arc-shaped part 272a against the pressing member 271 is detected, so that the cutting tool 142 can be moved to the slitting position. This is almost similarly applied to a case where the cutting tool 142 at the slitting position is moved to the non-slitting position. The cutting tool 142 at the slitting position can be moved to the non-slitting position by the disjunction spring 273 by driving the disjunction motor 274 in one predetermined direction until the abutment of the radial part 272b against the pressing member 271 is detected by the disjunction detecting switch 322.

As described above, in the cutting tool disjunction mechanism 135, the cutting tool is moved between the slitting position and the non-slitting position by controlling the driving of the disjunction motor on the basis of the disjunction detecting switch 322, so that the cutting tool 142 can be brought into contact with and separated from the processing tape T.

The cutting-tool moving mechanism 136 reciprocally moves the cutting tool carriage 134 in the tape width direction that is the vertical directions to thereby reciprocally move the cutting tool unit 131 supported by the mechanism in the tape width direction. As shown in FIGS. 6 and 8, the cutting-tool moving mechanism 136 includes a cutting tool moving motor 341 used as a power source for moving the cutting tool carriage 134, a cutting-tool moving power transmission mechanism 340 for transmitting the power of the cutting tool moving motor 341 to the cutting tool carriage, and a pair of carriage guide shafts 344 and 345 which extend in the tape width direction (vertical direction) and guides the movement of the cutting tool carriage 134. The cutting tool moving motor 341 is composed of a reversible stepping motor. The cutting tool moving motor is fixed to the outside of the vertical frame 27 so that its output shaft protrudes into the inside of the vertical frame 27 (see FIG. 8).

As shown in FIG. 8, the cutting-tool moving power transmission mechanism 340 is composed of a cutting-tool moving belt mechanism 342 which moves the cutting tool carriage 134 in the tape width direction, and a cutting-tool moving gear train 343 which transmits the power of the cutting tool moving motor 341 to the cutting-tool moving belt mechanism 342. The cutting-tool moving gear train 343 has a cutting-tool moving pinion 351 fixed to an output shaft of the cutting tool moving motor 341, and a cutting-tool moving pitch wheel 352 which is rotatably supported inside the vertical frame 27 and meshes with the cutting-tool moving pinion 351. As shown in FIG. 8, the cutting-tool moving belt mechanism 342 has a cutting-tool moving drive pulley 361 which is fixed on the same axis as the cutting-tool moving pitch wheel 352 and transmits the power of the cutting-tool moving pitch wheel 352, a pair of upper and lower cutting-tool moving driven pulleys 362 which are rotatably supported to the vertical frame 27 and is juxtaposed in the tape width direction, a cutting-tool moving middle pulley (tension pulley) 363 provided between the cutting-tool moving drive pulley 361 and the upper cutting-tool moving driven pulley 362, and a cutting tool movement timing belt 364 which is stretched between these pulleys. Also, the reciprocal range of a cutting tool carriage 134 is regulated by the pair of cutting-tool moving driven pulleys 362. The belt fixing part 253 of the cutting tool carriage 134 is fixed to the vertical part 364a of the cutting tool movement timing belt 364 which is stretched between the pair of cutting-tool moving driven pulleys 362.

The pair of carriage guide shafts 344 and 345 are supported by the lower frame 25 and the upper frame 26 and spaced apart in the tape feed direction. Also, the first carriage guide 254 of the cutting tool carriage 134 is inserted through the upstream carriage guide shaft 344 (hereinafter referred to as first carriage guide shaft 344), and the second carriage guide 255 engages with the downstream second carriage guide shaft 345. In addition, the second carriage guide shaft 345 serves as a drive shaft of a frame rotary cam 481 which constitutes the below-mentioned roller disjunction mechanism 471 and is rotatably supported to the lower frame 25 and the upper frame 26.

If the cutting tool moving motor 341 rotates forward and backward, the power is transmitted in the order of the cutting-tool moving pinion 351, the cutting-tool moving pitch wheel 352, and the cutting-tool moving drive pulley 361, whereby the cutting tool movement timing belt 364 travels forward and backward. Accordingly, the cutting tool carriage 134 fixed to the vertical part 364a moves forward and backward in the tape width direction, while it guides the pair of carriage guide shafts 344 and 345.

In addition, in a cutting tool movement range in which the cutting tool 142 can be reciprocated in the tape width direction by the cutting-tool moving mechanism 136, both the positions of the movable ends of the cutting tool 142 deviating from the tape feed path 31 are set to the movement base point positions of the cutting tool 142. Specifically, the position of an end of the cutting tool on the side of the lower frame 25 is set to the home position of the cutting tool 142, and the position of the other end of the cutting tool on the side of the upper frame 26 is set to a movement start position of the cutting tool in cutting processing.

If the movement of the cutting tool 142 which turns to the home position from a movement start position is defined as a forward movement and the movement of the cutting tool 142 which turns to the movement start position from the home position is defined as a backward movement, in this embodiment, the home position is an end position of the forward movement and a start position of the backward movement. On the other hand, the movement start position is a start position of the forward movement and an end position of the backward movement. In addition, the home position is also a standby position of the cutting tool 142 at the time of the non-cutting processing, etc.

The cutting tool carriage 134 is formed with a home position detecting piece 371 (see FIG. 7) extending vertically toward the lower frame 25, and the lower frame 25 is provided with a home-position detecting sensor 372 (photointerrupter). Accordingly, in the tape processing apparatus 1, the home position of the cutting tool 142 can be detected by the detection of the home position detecting piece 371. On the other hand, the movement start position is a position where the cutting tool 142 faces by driving the cutting tool moving motor 341 by a predetermined number of steps (in a predetermined direction of rotation), after the home position of the cutting tool 142 is detected by the home-position detecting sensor 372.

Incidentally, the movement start position of the cutting tool 142 is also a replacement position of the cutting tool unit 131. As shown in FIG. 1, the cutting tool replacement lid 381 is openably provided in the apparatus case 2 (upper case 3) so as to correspond to the replacement position of the cutting tool unit 131. Also, the cutting tool unit 131 is replaced by opening the cutting tool replacement lid 381 and rotating the cutting tool detaching lever 241 in a state where the cutting tool unit 131 faces the replacement position.

As described above, the tool holder 132 is supported by the cutting tool carriage 134 by the disjunction spring 273. Thereby, if the cutting tool detaching lever 241 is rotated for replacing the cutting tool unit 131, there are possibilities that an excessive force may act on the tool holder 132, and the tool holder 132 may move in the cutting tool disjunction direction. Accordingly, the tape processing apparatus 1 is provided with an electrode-holder holding mechanism 380, so that the force that the tool holder 132 receives is dispersed by the manual operation of the cutting tool detaching lever 241, and the tool holder 132 which faces the replacement position is held against the manual operation of the cutting tool detaching lever 241.

As shown in FIGS. 5 and 6, the electrode-holder holding mechanism 380 is composed of a locking projection 382 (salient) which is formed in the unit mounting part 201 of the tool holder 132 and protrudes toward the upper frame 26, and a locking hole 383 (concave portion) which is formed in the upper frame 26 so as to have a shape complementary to the locking projection 382 and fits on the locking projection 382. Thereby, when the cutting tool unit 131 faces the replacement position, the locking projection 382 of the unit mounting part 201 fits in the locking hole 383 of the upper frame 26.

Therefore, in the replacement position of the cutting tool unit 131, the tool holder 132 can be locked in the upper frame 26 and the force that the tool holder 132 receives can be released to the upper frame 26 at the time of attachment and detachment of the cutting tool unit 131, and the cutting tool is prevented from moving in a cutting tool disjunction direction, so that the interior of the apparatus can be prevented from being damaged by the cutting tool 142 at the time of replacing the cutting tool unit 131.

In this case, as shown in FIG. 6, since the engaging direction of the locking projection 382 and the locking hole 383 is orthogonal to the manipulation direction of the cutting tool detaching lever 241, the force that the tool holder 132 receives at the time of attachment and detachment of the cutting tool unit 131 can be efficiently released to the upper frame 26. Moreover, the disengagement of the locking projection 382 and the locking hole 383 by a manual operation can be prevented, and the posture of the tool holder 132 at the time of attachment and detachment of the cutting tool unit 131 can be held positively. In addition, in this embodiment, although the locking projection 382 is provided in the tool holder 132 and the locking hole 383 is provided in the upper frame 26, naturally, it is also possible to have a structure in which the locking hole 383 is provided in the tool holder 132 and the locking projection 382 is provided in the upper frame 26.

In addition, a series of operations for replacing the cutting tool unit 131 is performed using a predetermined key operation as a trigger. If a predetermined key operation for replacement of a cutting tool unit is performed, specifically, the position of the cutting tool 142 is first detected by the above-mentioned disjunction detecting switch 322. Here, in a case where the cutting tool 142 is in a slitting position, the disjunction motor 274 is driven and the cutting tool 142 is moved to the non-slitting position. Next, after the cutting tool moving motor 341 is driven and the home-position detecting sensor 372 detects the home position of the cutting tool unit 131, the cutting tool unit 131 is moved to a replacement position. When the cutting tool unit 131 is released from the replacement position, the cutting tool replacement lid 381 is locked so as not be opened. Also, if the cutting tool unit 131 faces the replacement position through the series of operations, opening of the cutting tool replacement lid 381 becomes possible, and replacement of the cutting tool unit 131 becomes possible.

As described above, in this embodiment, since replacement (attachment and detachment) of the cutting tool unit 131 is performed after the cutting tool unit 131 is made to face a predetermined replacement position and the tool holder 132 is held by the cutting-tool holding mechanism 380, the tool holder 132 and the surrounding area of the cutting tool 142 inside the apparatus can be prevented from being damaged due to the replacement of the cutting tool unit 131.

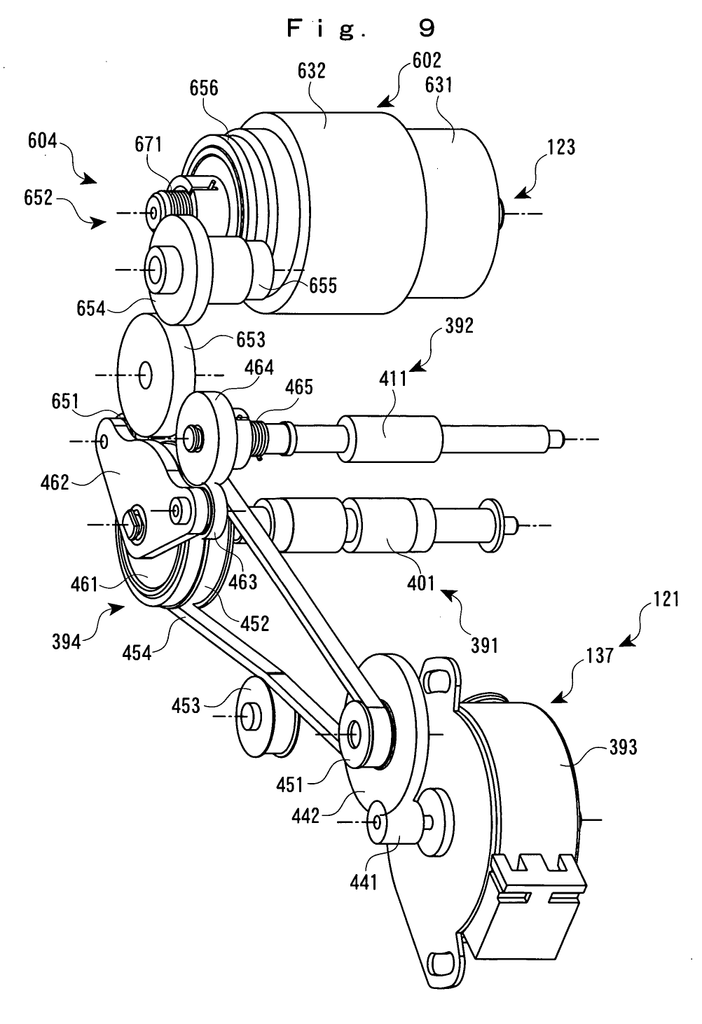

Next, the cutting feed mechanism 137 will be described. The cutting feed mechanism 137 is provided for feeding the processing tape T fed to the cutting unit 43 forward and backward for the cutting processing and guiding the processing tape to the tape ejecting slot 9. As shown in FIGS. 8 and 9, the cutting feed mechanism has a pair of feed rollers 391 and 392 which feed the processing tape T forward and backward, a cutting feed motor 393 which is adapted to rotate forward and backward, and a cutting feed power transmission mechanism 394 which transmits the power of the cutting feed motor 393 to the pair of feed rollers 391 and 392.

The pair of feed rollers 391 and 392 extend in the tape width direction and is spaced apart in the tape feed direction so as to sandwich the cutting tool unit 131 therebetween. As shown in FIGS. 6 and 8, the upstream feed roller 391 (hereinafter referred to as “forward and backward feed roller 391”) is a main roller and composed of grip rollers including a forward and backward driving roller 401 connected to the cutting feed motor 393 and a forward and backward follower roller (free roller) 402 which rotates according to rotation of the forward and backward driving roller 401. Similarly, the downstream feed roller 392 (hereinafter referred to as “tension roller 392”) is composed of a tension driving roller 411 connected to the cutting feed motor 393 and a tension follower roller (free roller) 412 which rotates according to rotation of the tension driving roller 411.

As described above, by making the pair of feed rollers 391 and 392 into a grip structure and disposing the feed rollers so as to sandwich the cutting tool unit 131 therebetween in the tape feed direction, the processing tape T in cutting processing can be prevented from deviating from the width direction due to cut resistance.

The forward and backward driving roller 401 and the tension driving roller 411 are rotatably supported by the lower frame 25 and the upper frame 26. Moreover, (two) driving roller openings (not shown) are formed in the vertical frame 27 (hereinafter referred to as “first path frame 421”) which constitutes the above-mentioned first feed path 32 and has the above-mentioned cutting tool receiving face correspondingly to the arrangement positions of both the driving rollers 401 and 411. The peripheral surfaces of both the driving rollers 401 and 402 protrude toward the first feed path 32 (see FIGS. 6 and 8) from the first path frame 421.

As shown in FIG. 8, the forward and backward follower roller 402 and the tension follower roller 412 face the first path frame 421 and are rotatably supported to the vertical frame 27 (hereinafter referred to as “second path frame 422”) which constitutes the first feed path 32 together with the first path frame 421. Two follower roller openings (not shown) for allowing both the follower rollers 402 and 412 to face the first feed path 32 are formed in the second path frame 422 so as to be spaced apart in the tape feed direction. The forward and backward follower roller 402 and the tension follower roller 412 protrude from the corresponding follower roller openings to the first feed path 32 and abut against the forward and backward driving roller 401 and the tension driving roller 411 (grip state).

In this case, as shown in FIG. 8, two sets of roller biasing springs 431 for biasing the follower roller 402 and 412 to the corresponding driving rollers 401 and 411 are interposed between each of the follower rollers 402 and 412 and the second path frame 422 (the side opposite to the tape feed path). It is possible to absorb aged deterioration, an error in the attachment position, etc. of each of the follower rollers 402 and 412 and to make each of the follower rollers 402 and 412 abut uniformly and flexibly against each of the driving rollers 401 and 411.

In addition, the second path frame 422 is formed substantially in the shape of an isosceles trapezoidal shape in plan view which expands toward the side opposite tape feed path. Also, an oblique side part 422a on the upstream side in the tape feed direction constitutes a portion of the above-mentioned tape buffer 125, and an oblique side part 422b on the downstream side in the tape feed direction constitutes a portion of the tape ejecting slot 9 (see FIGS. 6 and 8). Moreover, the cutting tool opening 432 extending in the tape width direction (vertical direction) correspondingly to the movement locus of the cutting tool unit 131 is formed in the second path frame 422, and the cutting tool unit 131 (cutting tool 142) faces the first feed path 32 from the cutting tool opening 432. Moreover, as shown in FIG. 6, six receiving grooves 433 for receiving three sets of below-mentioned width guide members 521 are formed between the cutting tool opening 432 and the tension follower roller 412 of the second path frame 422, and a slit 434 for allowing the below-mentioned path opening/closing member 681 to protrude and retract therethrough is formed on the upstream side of the follower roller opening in the tape feed direction corresponding to the forward and backward follower roller 402 (all will be described later for details).

The cutting feed motor 393 is composed of a reversible stepping motor and supplies power to the forward and backward driving roller 401 and the tension driving roller 411 and also supplies the power for take-up rotation to the take-up drum 602 (as will be described later) of the tape accommodating mechanism 123 by power changeover (see FIG. 9).

As shown in FIG. 9, the cutting feed power transmission mechanism 394 has a feed pinion 441 fixed to an output shaft of the cutting feed motor 393, a feed pitch wheel 442 which meshes with the feed pinion 441, a feed drive pulley 451 fixed on the same axis as the feed pitch wheel 442, a feed driven pulley 452 to which the base (lower frame 25 side) of the forward and backward driving roller 401 is fixed, a feed timing belt 454 which is stretched over the feed drive pulley 451, the feed middle pulley 453, and the feed driven pulley 452, a feed intermediate wheel 461 fixed on the same axis as the feed driven pulley 452, a substantially L-shaped feed carrier 462 rotatably supported to a gear shaft of the feed intermediate wheel 461, a feed transmission gear 463 which is rotatably supported to the feed carrier 462, which meshes with the feed intermediate wheel 461, and a tension driving gear 464 which is adapted to be meshed with the feed transmission gear 463 and to which a base (lower frame 25 side) of the tension driving roller 411 is fixed. Moreover, the feed intermediate wheel 461 meshes with the feed carrier 462, and a take-up transmission gear 651 (as will be described later) which is meshed with a take-up gear train 652 (as will be described later) which transmits power to the take-up drum 602 is rotatably supported to the take-up drum 602.

The operation of the cutting feed mechanism 137 will be described, taking the direction that the processing tape T is fed forward (fed toward the tape ejecting slot 9), i.e., the direction that the forward and backward driving roller 401 is rotated clockwise, as the forward driving (positive rotation) of the cutting feed motor 393. In a case where the cutting feed motor 393 is driven forward, power is transmitted to the feed pinion 441, the feed pitch wheel 442, the feed drive pulley 451, in this order, whereby the feed timing belt 454 travels, and the forward and backward driving roller 401 fixed to the feed driven pulley 452 rotates positively.

Moreover, if the cutting feed motor 393 is driven forward, the feed intermediate wheel 461 fixed to the feed driven pulley 452 rotates to transmit power to the feed transmission gear 463 and the take-up transmission gear 651, and accordingly, the feed carrier 462 rotates. As a result, the feed transmission gear 463 meshes with the tension driving gear 464, and the tension driving roller 411 fixed to the tension driving gear 464 rotates forward. Also, the take-up transmission gear 651 is disengaged from the take-up gear train 652 and idles, which brings the take-up drum 602 into a rotatable state.

In this case, the peripheral speed of the tension driving roller 411 is set to be slightly faster than the peripheral speed of the forward and backward driving roller 401, and the tension driving roller is slightly larger in the feed rate of the processing tape T than the forward and backward driving roller 401. Moreover, as shown in FIG. 9, a tension slip spring 465 (coil spring) which functions as a torque limiter is interposed between the tension driving gear 464 and the tension driving roller 411 so that the rotational torque at the time of the positive rotation of the tension driving roller 411 may become constant. That is, the processing tape T is fed forward while making a slip rotation of the tension driving roller 411. The tension driving roller 411 (tension roller 392) cooperates with the forward and backward driving roller 401 (forward and backward feed roller 391), so that the processing tape T can be fed forward, in a state where a proper tension is applied thereto.

On the other hand, if the cutting feed motor 393 is reversely driven, the feed driven pulley 452 rotates in a direction reverse to the direction at the time of the forward driving of the cutting feed motor 393 by the feed pinion 441, the feed pitch wheel 442, the feed drive pulley 451, and the feed timing belt 454, and the forward and backward driving roller 401 rotates backward. Moreover, the feed carrier 462 also rotates in a direction reverse to the direction at the time of the forward driving of the cutting feed motor 393, and the feed transmission gear 463 is disengaged from the tension driving gear 464 to bring the tension driving roller 411 into a rotatable state. Also, the take-up transmission gear 651 meshes with the take-up gear train 652 to transmit power to the take-up drum 602, and the take-up drum 602 rotates for take-up. Therefore, the backward feed of the processing tape T is performed by the forward and backward driving roller 401 (cooperation with the take-up drum 602), and the tension driving roller 411 rotates according to the backward feed of processing tape T.

Incidentally, when the forward and backward feed roller 391 and the tension roller 392 are in a grip state at the time of the printing processing by the printing unit 41, since the processing tape T (i.e. its leading edge) strikes against both the rollers 391 and 392 to interfere with printing feed, a suitable printing processing cannot be performed. Accordingly, in the cutting mechanism 121 of this embodiment, a roller disjunction mechanism 471 which moves the forward and backward follower roller 402 and the tension follower roller 412 is provided between a grip position where both the rollers 391 and 392 are in a grip state (abut against a driving roller), and a non-gripping position where both the rollers 391 and 392 are in a non-gripping state (are spaced from a driving roller), so that the feed path of the processing tape T during the printing processing can be secured, and the setting of both the rollers 391 and 392 can be prevented (see FIGS. 6 to 8).

As shown in FIG. 8, an upstream end of the second path frame 422 in the tape feed direction is disposed near the above-mentioned full cutter 81 and is rotatably supported to the lower frame 25 and the upper frame 26 by the frame pivot 472. In addition, for the convenience of description, the face on the side of the tape feed path of the second path frame 422 is assumed as a front face, and the face on the side opposite to the tape feed path thereof is assumed as a back face. The roller disjunction mechanism 471 moves the forward and backward follower roller 402 and the tension follower roller 412 between the grip position and the non-gripping position by rotating the second path frame 422 and includes a pair of (two) frame rotary cams 481 for rotating the second path frame 422, a frame biasing spring which biases the second path frame 422 against the frame rotary cam 481 (return spring: not shown), the above-mentioned disjunction motor 274 which supplies rotational power to the pair of frame rotary cams 481, and a rotational power transmission mechanism 482 which transmits the power of the disjunction motor 274 to the pair of frame rotary cams 481.

As shown in FIG. 7, the pair of frame rotary cams 481 are fixed onto the above-mentioned second carriage guide shaft 345 while they are spaced apart in the axial direction and are disposed on the back face side of the second path frame 422. The pair of frame rotary cams 481 are substantially fan-shaped plate cams in plan view, which are similarly formed, and abut against the back faces of both ends of the second path frame 422 in the tape feed direction on the side of a rotating end of the second path frame 422, to thereby rotate about the frame pivot 472. The frame biasing spring biases the second path frame 422 toward the side opposite to the tape feed path to make the side end face of the pair of frame rotary cams 481 abut against the second path frame 422.

As shown in FIG. 7, the rotational power transmission mechanism 482 transmits the power of the disjunction motor 274 performing rotational driving in a predetermined direction to the pair of frame rotary cams 481 by the second carriage guide shaft 345 and is composed of the disjunction worm 331, disjunction worm wheel 332, disjunction first gear 333, disjunction carrier 334, and disjunction transmission gear 335, a first rotary gear 491 which is rotatably supported to the lower frame 25 and adapted to be meshed with the disjunction transmission gear 335, a second rotary gear 492 which is rotatably supported to the lower frame 25 and meshes with the first rotary gear 491, and a rotation driving gear 493 fixed to the base side (lower frame 25 side) of the second carriage guide 255 while meshing with the second rotary gear 492.

In the roller disjunction mechanism 471, if the disjunction motor 274 performs rotational driving in one predetermined direction (for example, reverse direction) opposite to that in the case where the above-mentioned cutting tool disjunction mechanism 135 is driven, the disjunction carrier 334 rotates in a direction reverse to that in the case where power is transmitted to the cutting tool disjunction mechanism 135, and the disjunction transmission gear 335 (is disengaged from the disjunction cam drive gear 336) meshes with the first rotary gear 491. Accordingly, power is transmitted in the order of the second rotary gear 492 and the rotation driving gear 493 from the first rotary gear 491, and the frame rotary cam 481 rotates with the second carriage guide shaft 345.

Also, if the arc-shaped part 481a of the frame rotary cam 481 abuts against the back face of the second path frame 422, the second path frame 422 rotates toward the tape feed path against the frame biasing spring and moves the forward and backward follower roller 402 and the tension follower roller 412 to the grip position. On the other hand, if a radial part 481b of the frame rotary cam 481 abuts against the back face of the second path frame 422, the second path frame 422 rotates toward the side opposite to the tape feed path, and the forward and backward follower roller 402 and the tension follower roller 412 moves to the non-gripping position. That is, the back face of the second path frame 422, which functions as a cam follower, positively transforms a rotary motion of the frame rotary cam 481 into a rotational motion of the second path frame 422 in cooperation with the frame biasing spring which is not shown.

As shown in FIG. 7, a rotation detecting cam 495 is fixed to the rotation driving gear 493, and a rotation detecting switch 496 turned on and off by the rotation detecting cam 495 is disposed in the lower frame 25, thereby making it possible to detect whether or not the forward and backward follower roller 402 and the tension follower roller 412 are in the grip position on the basis of the rotational position of the frame rotary cam 481. Therefore, by controlling driving of the disjunction motor 274 on the basis of the detection result by the rotation detecting switch 496, the forward and backward follower roller 402 and the tension follower roller 412 can be moved to the non-gripping position at the time of printing processing and can be moved to the grip position at the time of cutting processing, so that both the printing processing and cutting processing can be properly performed to processing tape T.

In addition, as described above, the second carriage guide shaft 345 guides movement of the cutting tool carriage 134. Thus, in this embodiment, the cam drive shaft for rotating the pair of frame rotary cams 481 is made to serve as a moving guide shaft (second carriage guide shaft 345) of the cutting tool carriage 134, so that rattling of the cutting tool carriage 134 at the time of the cutting processing resulting from the dimensional tolerance between the cutting tool carriage 134 (second carriage guide 255 used as the bearing part of the second carriage guide shaft 345) and the second carriage guide shaft 345 can be effectively prevented.

That is, when the pair of frame rotary cams 481 press the second path frame 422 toward the above-mentioned grip position at the time of cutting processing, the reaction force from the second path frame 422 acts on the second carriage guide shaft 345, and the second carriage guide shaft 345 receives the force at the non-gripping position. Therefore, at the time of the cutting processing, the second carriage guide shaft 345 abuts against the guide rolling-contact roller 262 at the non-gripping position of the second carriage guide 255, and the gap caused by a dimensional tolerance is maintained in the state where it is brought near to the grip position side. Therefore, the rattling of the second carriage guide 255 and the second carriage guide shaft 345 resulting from a cut resistance that the cutting tool 142 receives can be prevented, and movement of the cutting tool carriage 134 can be stably guided. In addition, although the gap caused by a dimensional tolerance also exists between the second carriage guide shaft 345 and bearing parts in the lower frame 25 and the upper frame 26, the rattling at the time of the cutting processing resulting from this gap can be absorbed by the above-mentioned roller biasing spring 431.

Moreover, similarly, the rattling caused by a dimensional tolerance between the first carriage guide 254 and the first carriage guide shaft 344 is prevented by the action of the cutting tool disjunction mechanism 135 (the disjunction cam shaft 272 and the disjunction spring 273).

Next, the blade edge direction setting mechanism 138 will be described. As shown in FIGS. 5 and 8, the blade edge direction setting mechanism 138 is composed of a cutting-tool-side magnet 501 (movable magnet) involved in the cutting tool unit 131 and a frame-side magnet 502 (stationary magnet) fixed to the upper frame 26 at the movement start position of the cutting tool 142. The cutting-tool-side magnet 501 is composed of a cylindrical permanent magnet (bar magnet). A magnet insertion opening 511 diametrically formed so as to pass through the axial center of the cutting tool holding block 171 (cutting tool holding member 143) is provided in approximately the center position of the above-mentioned cutting tool holding block 171, and the cutting-tool-side magnet 501 is inserted through and fixed to this magnet insertion opening 511. The frame-side magnet 502 is also composed of a permanent magnet, and this magnet is fixed to a portion of the upper frame 26 so as to be close to a movement start position to approach/face the cutting-tool-side magnet 501, in order to make the frame-side magnet act on the cutting-tool-side magnet 501.

Therefore, when the cutting tool 142 approaches or faces the movement start position, the attractive action of the mutually different magnetic poles of the cutting-tool-side magnet 501 and the frame-side magnet 502 rotates the cutting tool 142 by the cutting tool holding member 143 and turns the cutting edge of the cutting tool 142 to a predetermined direction (tape width direction in this embodiment). Accordingly, the slitting start angle of the cutting tool 142 on the processing tape T can be made constant. Also, in this embodiment, since the cutting edge of the cutting tool 142 turns to the tape width direction, it is possible to slit the processing tape T at right angles from its end edge.

In the cutting mechanism 121 constructed as described above, cutting processing is performed by synchronously driving the cutting-tool moving mechanism 136, the cutting tool disjunction mechanism 135, and the cutting feed mechanism 137. That is, by synchronously performing the forward and backward feed of the processing tape T by the cutting feed mechanism 137 and (reciprocal) movement of the cutting tool unit 131 (cutting tool 142) in the tape width direction by the cutting-tool moving mechanism 136 while the cutting tool 142 is properly moved up and down in cutting processing by the cutting tool disjunction mechanism 135, a cut line having a desired shape is formed in the processing tape T (tape Tc for separated characters).

Next, the width guide mechanism 122 will be described with reference to FIGS. 3 to 5. The width guide mechanism 122 is provided for guiding processing tapes T having a width of 4 mm to 36 mm, more specifically, processing tapes T having a width of 18 mm, 24 mm, and 36 mm in the tape width direction. This width guide mechanism prevents the processing tapes T having the three kinds of width from deviating from their width direction at the time of the slitting operation by the cutting tool 142, and the forward and backward feed of the processing tapes T.

As shown in FIGS. 4 and 5, the width guide mechanism 122 includes three sets of six width guide members 521 which correspond to the three kinds of tape width, respectively and guide the processing tapes T in their width direction, and a guide protruding/retracting member 522 which protrudes each set of width guide members 521 from the above-mentioned first path frame 421 to the tape feed path 31 or retracts each set of width guide members from the tape feed path to the first path frame.

The three sets of six width guide members 521 are aligned and disposed in the tape width direction. Specifically, the outer two width guide members 521 (large-width guide members) correspond to a processing tape T having a width of 36 mm, the two width guide members 521 (middle width guide members) adjacent to the width guide members 521 for the processing tape having a width of 36 mm correspond to a processing tape T having a width of 24 mm, and the two innermost guide members 521 (small-width guide members) correspond to a processing tape T having a width of 18 mm.

As shown in FIG. 4, each width guide member 521 has a substantially rectangular guide base 531 which is long in the tape feed direction in plan view, and a pair of (two) guide parts 532 which are spaced in the tape feed direction while protruding toward the first feed path from the guide base 531. The guide base and the guide parts are formed integrally. A pair of (two) cam-receiving openings 541 spaced in the tape feed direction are formed in the guide base 531. Moreover, a spring locking projection 542 for locking the below-mentioned retraction spring (not shown) is formed in approximately the center position (position of center of gravity) of the guide base 53, and the end of the guide base 531 on the side opposite to the first feed path is folded back to form a spring groove 543 which accommodates the retraction spring.

Although not shown in the figure, twelve guide protruding/retracting slots which allow the respective guide parts 532 to protrude to and retract from the tape feed path 31 therethrough are provided in the first path frame 421 in such a manner as to correspond to the protruding/retracting positions of the respective guide parts 532. The pair of guide parts 532 of each of large, middle, and small width guide members 521 selectively protrude to and retract from the tape feed path 31, and regulate a processing tape T having a corresponding tape width in its width direction. In this case, each guide part 532 on the upstream side in the tape feed direction protrudes to and retracts from a branching portion 33 that the second feed path 34 branches from the first feed path 32, and each guide part 532 on the downstream side in the tape feed direction protrudes to and retracts from a portion of the above-mentioned tension roller 392 closest to the upstream side thereof (see FIG. 3).

As described above, since the pair of guide parts 532 protrude in the tape feed path 31 so as to sandwich the cutting tool 142 on the upstream and downstream sides of the first feed path 32, deviation of a processing tape T in the tape width direction caused by a cut resistance can be prevented effectively. Moreover, a processing tape T located in the second feed path 34 as well as a processing tape T located in the first feed path can be guided in the width direction by causing the upstream guide part 532 to protrude to and retract from the branching portion 33. Accordingly, meandering of the processing tape T is prevented positively.

In addition, the width guide members 521 of this embodiment are made of a material, for example, fluororesin, which does not adhere to the adhesive face of the tape Tc for separated characters which constitutes the processing tape T. Therefore, even in a case where an adhesive face has protruded the end face of a processing tape T, the processing tape T does not adhere to the width guide member 521, and the width guide member 521 can guide the feed of the processing tape T smoothly.

As shown in FIG. 4, the guide protruding/retracting member 522 includes a retraction spring which biases each width guide member 521 in a retracting direction from the tape feed path 31, a pair of (two) guide cam mechanisms 552 which selectively protrude and retract the same set of width guide members 521, the above-mentioned full cutting motor 82 used as a power source of the pair of guide cam mechanisms 552, and a guide power transmission mechanism 553 which transmits the power of the full cutting motor 82 to the guide cam mechanism 552.

The retraction spring is composed of a deformed “V”-shaped torsion spring, and it is accommodated in and held by the guide base 531 (spring groove 543), with the spring locking projection 542 inserted through a torsion part of the retraction spring. In this case, an approximately intermediate position of the guide base 531 in the tape feed direction is cut away toward the spring locking projection 542 from the tape feed path side. As the torsion part (leading edge on the side of the tape feed path) of the retraction spring abuts against the face of the first path frame 421 on the side opposite to the tape feed path, i.e., the back face thereof from this cut-away part, it biases the width guide member 521 in the retracting direction.

As shown in FIGS. 3 and 4, the pair of guide cam mechanisms 552 correspond to the pair of cam-receiving openings 541 formed in each width guide member 521. That is, one cam-receiving opening corresponds to the cam-receiving opening 541 on the upstream side in the tape feed direction, and the other cam-receiving opening corresponds to the cam-receiving opening 541 on the downstream side in the tape feed direction. Also, each guide cam mechanism 552 is configured similarly and has three sets of six guide cams 561 corresponding to the three sets of six width guide members 521, and a guide cam drive shaft 562 to which the three sets of six guide cams 561 are fixed.

Each guide cam 561 is composed of a plate cam, with its apexes chamfered, which is substantially rectangular in plan view. As shown in FIGS. 3 and 4, each set of guide cams 561 are fixed to each guide cam drive shaft 562 so as to be offset with a different rotational phase from a different set of guide cams 561. More specifically, each set of guide cams 561 is offset by 90 degrees or 180 degrees in rotational phase from the other sets of guide cams 561, a guide cam is fixed to the guide cam drive shaft 562 to protrude therefrom in the shape of “T” in plan view. Also, each guide cam drive shaft 562 is loosely inserted through the corresponding cam-receiving opening 541 and is rotatably supported to the lower frame 25 and the upper frame 26.

Therefore, the outer peripheral surface of a corresponding guide cam 561 abuts against the inner peripheral surface of the cam-receiving opening 541 of each width guide member 521. Also, if the guide cam 561 is rotated by the guide cam drive shaft 562, the width guide member 521 corresponding to the angle of rotation of the guide cam is translated in the guide protruding/retracting direction (the same direction as the cutting tool attachment/detachment direction and cutting tool disjunction direction) which is orthogonal to the tape feed path 31, so that the guide part 532 moves to protrude and retract between a protruding position where the guide part 532 protrudes from the first path frame 421 to allow guiding of a processing tape T in the width direction, and a retracting position where the guide part 532 retracts into the first path frame 421. In this case, since the rotational phases of the same set of guide cams 561 are the same, the same set of width guide members 521 are translated similarly to cause the same set of guide parts 532 to protrude and retract simultaneously.

The guide power transmission mechanism 553 is composed of the above-mentioned full cutting worm 101, full cutting worm wheel 102, full cutting first gear 103, full cutting carrier 104, and full cutting transmission gear 105, a first guide gear 571 which is adapted to be meshed with the full cutting transmission gear 105, a second guide gear 572 fixed on the same axis as the first guide gear 571, a first guide driving gear 573 which meshes with the second guide gear 572 and to which the upstream guide cam drive shaft 562 is fixed, and a second guide driving gear 574 which meshes with the second guide gear 572 and to which the downstream guide cam drive shaft 562 is fixed.

Also, if the full cutting motor 82 is rotated in a direction reverse to that in the case where power is supplied to the full cutting unit 42, the full cutting carrier 104 rotates in a direction reverse to that in the case where power is transmitted to the full cutting unit 42. Also, the full cutting transmission gear 105 is disengaged from the full cutting second gear 111, and it meshes with the first guide gear 571 to transmit the power from the full cutting first gear 103 to the first guide gear 571 and the second guide gear 572 in this order. The first guide driving gear 573 and the second guide driving gear 574 rotate in the same direction. In addition, the first guide driving gear 573 and the second guide driving gear 574 are configured to have the same number of teeth, and the pair of guide cam drive shafts 562 rotate at the same circumferential speed. Accordingly, the pair of guide parts 532 formed in the same width guide member 521 protrude to and retract from the tape feed path 31 simultaneously, and each set of guide parts 532 protrude and retract selectively.

In addition, as shown in FIG. 4, a first guide detecting cam 582 which turns on and off a first guide detecting switch 581 (see FIG. 10) (not shown in FIG. 4) fixed to the lower frame 25 is fixed to the first guide driving gear 573. Similarly, a second guide detecting cam 592 which turns on and off a second guide detecting switch 591 (see FIG. 10) (not shown in FIG. 4) fixed to the lower frame 25 is fixed to the second guide driving gear 574. On the basis of the combination of ON/OFF of the first guide detecting cam 582 and the second guide detecting cam 592, the position of each set of width guide members 521 (guide parts 532) can be grasped.

In this way, in the width guide mechanism 122, a rotary motion of each guide cam is transformed into a translation of the width guide member 521 in the guide protruding/retracting direction by using each width guide member 521 as a follower (cam follower), thereby causing the guide part 532 to protrude to and retract from the tape feed path 31. In this case, since the movement of the width guide member 521 is performed by the pair of guide cam mechanisms 552 spaced in the tape feed direction, each width guide member stably performs a parallel translation in the guide protruding/retracting direction without inclining the width guide member. Moreover, since the width guide member 521 is adapted to be translated in the guide protruding/retracting direction by the pair of guide cam mechanisms 552, the apparatus can be constructed relatively compact as compared with a structure in which the width guide member 521 is rotated to cause the guide part 532 to protrude and retract.

Moreover, in this embodiment, all the width guide members 521 are movable in the guide protruding/retracting direction, and when one short side part 561a of the guide cam 561 which protrudes diametrically of the guide cam drive shaft 562 abuts against the inner peripheral part of the cam-receiving opening 541 on the side of the tape feed path parallel to the tape feed direction, the guide part 532 moves to the protruding position. Also, since the six guide cams 561 protrude from each guide cam drive shaft 562 of this embodiment in the shape of “T” in plan view, all the guide parts 532 can be retracted. That is, the cam curve of each guide cam mechanism 552 has a curvilinear part which allows all the guide parts 532 to be retracted. Therefore, even a tape cartridge C in a state where a processing tape T is supplied to some extent can be attached to or detached from, the tape processing apparatus 1 (cartridge mounting part 8) by moving all the guide parts 532 to the retracting position.

In addition, in this embodiment, although the pair of guide cam drive shafts 562 are adapted to be rotated in same direction, they may be rotated in directions opposite to each other. If the pair of guide cam drive shafts 562 are rotated in directions opposite to each other, when the guide cam 561 slides and rotates in the cam-receiving opening 541, a force generated in the tape feed direction can be offset mutually, and the width guide member 521 can be stably moved. In this case, the guide cam 561 is also fixed to each guide cam drive shaft 562 so that the pair of guide parts 532 formed in the same width guide member 521 may protrude or retract simultaneously, that is, so that the pair of guide cam drive shafts 562 may be axially symmetrical with respect to the tape feed direction.

Next, the tape accommodating mechanism 123 will be described. The tape accommodating mechanism 123 is provided for cutting a processing tape T supplied from the tape cartridge C and performing cutting processing on the cut processing tape T (clipping processing: it will be described later). A trailing end of a processing tape T which is fed forward and backward by cutting processing can be processed in the apparatus by accommodating the trailing end (cut end) of the processing tape T fed backward so that it can be taken in or out of the tape cartridge.

As shown in FIG. 3, the tape accommodating mechanism 123 includes a tape accommodating section 601 connected to the second feed path 34, a take-up drum 602 which is disposed in the tape accommodating section 601 to wind up a processing tape T fed through the second feed path 34, from the trailing end of the tape, a tape biasing mechanism 603 which biases the processing tape T fed to the tape accommodating section 601 so that the tape is pressed against the outer peripheral surface of the take-up drum 602, the above-mentioned cutting feed motor 393, and a take-up power transmission mechanism 604 which transmits the power of the cutting feed motor 393 to the take-up drum 602 to rotate the drum in a take-up direction of the processing tape T.

As shown in FIG. 3, the tape accommodating section 601 is a space having a circular cross section, which is formed within a housing member 621 (see FIGS. 3 and 5) which constitutes a portion of the apparatus case 2, and it has a tape-introducing opening 611 for guiding a processing tape T from a tangential direction through the second feed path 34. An accommodating section opening and closing lid 622 (see FIGS. 1 to 3) for opening the tape accommodating section 601 sideways is provided in the housing member 621 and adapted to be accessible into the tape accommodating section 601 from the outside. In addition, the housing member 621 constitutes the tape ejecting slot 9 together with the above-mentioned second path frame 422 and also constitutes a portion of the second feed path 34 which guides a processing tape T to the tape accommodating section 601.

As shown in FIGS. 3, 5 and 9, the take-up drum 602 is composed of a drum body 631 rotatably supported by the upper frame 26 and the housing member 621 and an anti-slip ring 632 provided on an outer peripheral surface of the drum body 631. A fitting groove 633 is formed in the drum body 631 to conform to the width of the anti-slip ring 632, and a cylindrical anti-slip ring 632 is fitted in the fitting groove 633. The anti-slip ring 632 is made of rubber, etc., having a coefficient of friction with a processing tape T, and prevents the slip of the processing tape T with respect to the take-up drum 602 so that the processing tape T may be easily wound up around the take-up drum 602. The take-up drum 602 is disposed concentrically with the tape accommodating section 601 which is formed in a round cross-sectional shape, so that the inner wall face of the tape accommodating section 601 can be used as a guide at the time of take-up of a processing tape T.

As shown in FIG. 3, the tape biasing mechanism 603 biases a processing tape T fed to the tape accommodating section 601 against the peripheral surface of the take-up drum 602 so that the processing tape T is appropriately wound up around the take-up drum 602. The tape biasing mechanism has a pressing plate 641 which presses the processing tape T against the peripheral surface of the take-up drum 602, and a pair of pressing springs (not shown) which press the pressing plate 641 against the peripheral surface of the take-up drum 602.

The pressing plate 641 is adapted to correspond to the tape width of a processing tape T having a maximum width (36 mm in this embodiment) and is rotatably supported to the lower frame 25 and the upper frame 26 in an approximate intermediate position of the second feed path 34. Also, a pressing spring (torsion coil spring: not shown) is incorporated in bearings (not shown) of the pressing plate 641 in the lower frame 25 and the upper frame 26, respectively, and the pressing plate 641 is biased toward the take-up drum 602. As shown in FIG. 3, the pressing plate 641 extends in the tape accommodating section 601 from an approximately intermediate position of the second feed path 34 to abut against the take-up drum 602 and constitutes the second feed path 34 together with the housing member 621. Accordingly, the processing tape T which has been fed through the second feed path 34 is positively pressed against the take-up drum 602 by the pressing plate 641, and the processing tape is appropriately wound around the rotating take-up drum 602 with its own curling.

As shown in FIG. 9, the take-up power transmission mechanism 604 has the above-mentioned feed pinion 441, feed pitch wheel 442, and feed drive pulley 451, and a take-up gear train 652 to which power is transmitted from the feed driven pulley 452 to which the base (lower frame 25 side) of the forward and backward driving roller 401 is fixed, the feed timing belt 454, the feed intermediate wheel 461, the feed carrier 462, the take-up transmission gear 651, and the take-up transmission gear 651. The take-up gear train 652 is composed of a first take-up gear 653 which can be meshed with the take-up transmission gear 651, a second take-up gear 654 which meshes with the first take-up gear 653, a third take-up gear 655 fixed on the same axis as the second take-up gear 654, and a take-up driving gear 656 which meshes with the third take-up gear 655 and is fixed to the lower frame side of the take-up drum 602 (drum body 631).

If the cutting feed motor 393 is driven reversely as described above, the take-up transmission gear 651 meshes with the take-up gear train 652 to transmit the power of the cutting feed motor 393 to the take-up gear train 652, thereby rotating the take-up drum for take-up. Accordingly, a processing tape T fed to the tape accommodating section 601 is wound in around the take-up drum 602 from the trailing end thereof. In this case, as shown in FIGS. 5 and 9, the take-up slip spring 671 (coil spring) is interposed between the housing member 621 and a shaft end of the take-up drum 602 (torque limiter), and the take-up torque of the take-up drum 602.is kept constant. Moreover, the amount of take-up per unit time of a processing tape T by the take-up drum 602 is set to be slightly larger than the amount of backward feed per unit time of the above-mentioned forward and backward driving roller 401, so that a proper tension is applied to a processing tape T at the time of backward feed by using the above-mentioned take-up torque as a limit.

On the other hand, when the cutting feed motor 393 is driven forward, the take-up transmission gear 651 is disengaged from the take-up gear train 652 and idles. Therefore, according to the forward feed of the processing tape T by the cutting feed mechanism 137, the take-up drum 602 rotates and processing tape T wound up around the take-up drum 602 is supplied.

In this way, since the power source of the take-up drum 602 is also used as a power source of the cutting feed mechanism 137, with a comparatively simple configuration, the take-up drum 602 can be rotated in synchronization with the feed of a processing tape T, and the feed of the processing tape T can be maintained in an appropriate state.

Next, the path change mechanism 124 will be described. As shown in FIGS. 6 and 8, the path change mechanism 124 is provided for guiding a trailing end of a processing tape T to the second feed path 34 prior to the clipping processing. This path change mechanism includes a path opening/closing member 681 which opens and closes the first feed path 32 in the branching portion 33 in which the second feed path 34 branches from the first feed path 32, and an opening/closing member moving mechanism 682 which is adapted to be capable of moving the path opening/closing member 681 between a first position where the first feed path 32 is opened and a second position where the first feed path 32 is blocked up.

As shown in FIG. 6, the path opening/closing member 681 has its end rotatably supported to the above-mentioned second path frame 422. As shown in FIG. 6, a slit 434 formed integrally with the above-mentioned upstream follower roller opening is formed in the second path frame 422. If the path opening/closing member 681 rotates between the first position and the second position, the rotating end of the path opening/closing member 681 protrudes to and retracts from the first feed path 32 through this slit 434, so that the first feed path 32 will be opened and closed.

As shown in FIG. 6, the opening/closing member moving mechanism 682 has a pair of path opening/closing springs (torsion coil springs: not shown) which bias the path opening/closing member 681 so as to face the first position and an engagement piece 691 which is formed integrally with the path opening/closing member 681, and an actuating piece 692 which is formed integrally with the above-mentioned cutting tool carriage 134 and which can be detachably engaged with the engagement piece 691. The pair of path opening/closing springs are incorporated in a bearing of the path opening/closing member 681 provided in the second path frame 422 and are composed of torsion coil springs. The engagement piece 691 is provided at the end of the path opening/closing member 681 on the side of its rotating shaft and on the side of the movement start position (upper frame 26 side). Also, the engagement piece is formed approximately perpendicularly with respect to the path opening/closing member 681 and protrudes from the second path frame 422 toward the cutting tool carriage 134. As shown in FIG. 6, the actuating piece 692 is provided on an end face of the cutting tool carriage 134 on the side of its movement start position and is engaged with or disengaged from the engagement piece 691, along with the movement of the cutting tool carriage 134. The actuating piece 692 has an inclined plane 692a whose upstream end in the tape feed direction is located closer to the movement start position than its downstream end, and this inclined plane 692a engages with the engagement piece 691 to cause a cam action which rotates the path opening/closing member 681.

That is, the movement of the cutting tool carriage 134 to the movement start position causes the inclined plane 692a of the actuating piece 692 to press the engagement piece 691 and causes the path opening/closing member 681 which faces the first position to rotate toward the second position (counter clockwise) against the path opening/closing spring. Also, when the cutting tool carriage 134 moves to the movement start position, the path opening/closing member 681 moves to the second position to block the first feed path 32. On the other hand, if the cutting tool carriage 134 moves toward the home position from the movement start position, the biasing force of the path opening/closing spring causes the engagement piece 691 to rotate along the inclined plane 692a of the actuating piece 692 (clockwise) and causes the path opening/closing member 681 to rotate toward the first position. Also, if the actuating piece 692 is disengaged from the engagement piece 691, the path opening/closing member 681 faces the first position and opens the first feed path 32.

In this way, the opening/closing member moving mechanism 682 is a cam mechanism (swash cam) in which the actuating piece 692 is used as a cam and the engagement piece 691 is used as a follower (cam follower), and the opening/closing member moving mechanism is adapted to transform the reciprocation of the cutting tool carriage into the rotational motion of the path opening/closing member 681 to open and close the first feed path 32. Also, in this embodiment, since the actuating piece 692 and the engagement piece 691 are adapted to engage with each other at the movement start position, the first feed path 32 can be blocked by using the movement of the cutting tool carriage 134 accompanying the start of the cutting processing. Therefore, the trailing end of a processing tape T fed backward can be positively guided to the second feed path 34 by moving the cutting tool carriage 134 to the movement start position prior to the backward feed start of the processing tape T. After completion of the backward feed, the processing tape can be quickly shifted to the cutting operation.

Next, the tape buffer 125 will be described. The tape buffer 125 is used in a case where cutting processing (decorative half-cutting processing: it will be described later) is performed while a non-cut processing tape T which has been supplied from the tape cartridge C is fed forward and backward, to absorb any sagging caused by feeding the non-cut processing tape T backward.

As shown in FIG. 8, the tape buffer 125 is a concave space which faces the first feed path 32 and extends from the above-mentioned full cutter 81 to the branching portion 33 of the tape feed path 31. The oblique side part 422a of the second path frame 422 on the upstream side in the tape feed direction constitutes a portion of the wall surface of the tape buffer. As described above, the processing tape T of this embodiment is accommodated in a state where it is wound in the tape cartridge C, and thus has curling. The tape buffer 125 of this embodiment is provided corresponding to a curling direction of the processing tape T and is formed on the convex side (deflection side) of the processing tape T which is deflected due to the curling, in the tape feed path 31.

In this way, by providing the tape buffer 125 on the upstream side of the cutting feed mechanism 137 on the downstream side of the tape supply slot of the tape cartridge C in the tape feed direction, a non-cut processing tape T can also be fed backward, though it is slight. As a result, it is possible to perform cutting processing accompanied by the backward feed. More specifically, the tape buffer is used in a case where a cut line is made into a trimming shape in the below-mentioned decorative half-cutting processing.

Next, a main control system of the tape processing apparatus 1 will be described. As shown FIG. 10, the tape processing apparatus 1 includes a data input/output section 701 which has a keyboard 5, a display 6, etc., and inputs and outputs a variety of information for printing processing and cutting processing, and various commands, a driving section 702 which has various drivers which drive the print head 62, the printing feed motor 72, the full cutting motor 82, the disjunction motor 274, the cutting tool moving motor 341, and the cutting feed motor 393, a detection section 703 which has the tape identification sensor 51, the home-position detecting sensor 372, the disjunction detecting switch 322, the rotation detecting switch 496, the first guide detecting switch 581, and the second guide detecting switch 591, and performs a variety of detections, and a control section 704 (control unit 44) which is connected to these respective sections to control the whole tape processing apparatus 1.

The control section 704 is provided with a RAM 711 which has a storage region capable of temporarily storing data and is also used as an operation region for control processing, a ROM 712 which has various storage regions and stores control programs and control data, a CPU 713 which performs arithmetic processing on various kinds of data, a peripheral control circuit (P-CON) 714 in which logic circuits for processing interface signals with peripheral circuits are incorporated and timers (not shown) for performing time control are built, and buses 715 which connects these with one another.

Also, the control section 704 makes the CPU 713 execute arithmetic processing on the various kinds of data input from the respective sections by the P-CON 714 and the various kinds of data in RAM 711 according to the control programs stored in the ROM 712 and makes it output the processing results (control signals) to the various kinds of drivers by the P-CON 714. Accordingly, the respective sections are generally controlled, whereby the whole apparatus is controlled.

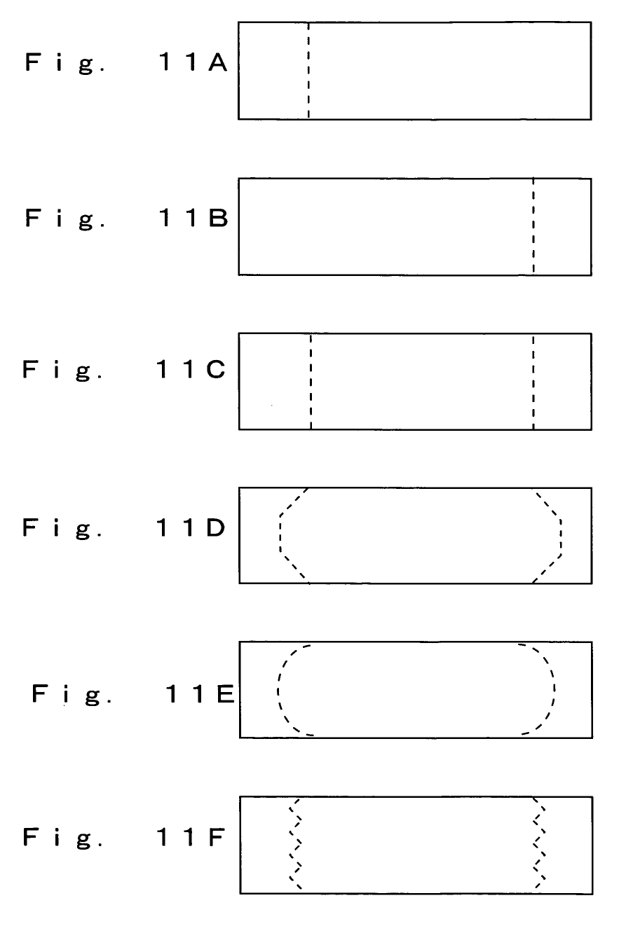

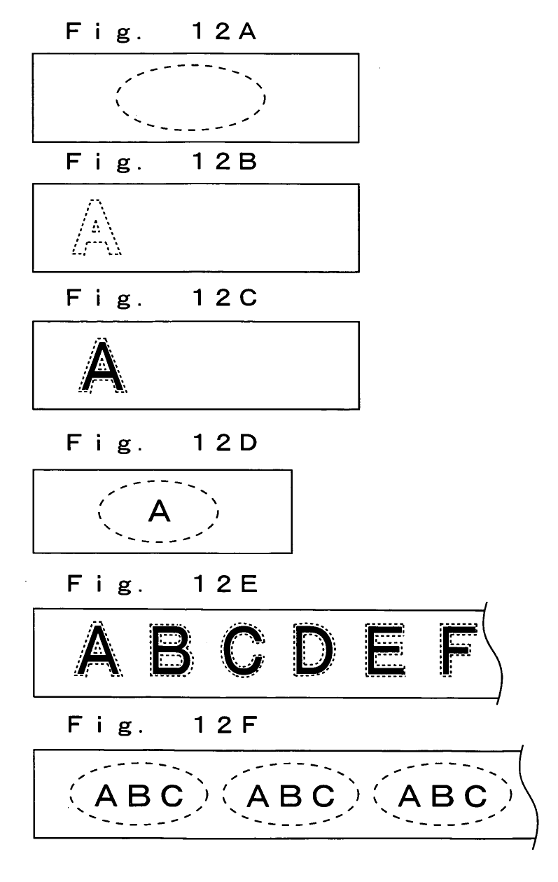

Also, the cutting processing performed by the above-mentioned cutting unit 43 can be generally classified into a half-cutting processing which forms cut lines (half-cutting lines) in a processing tape T so as to traverse the tape width direction, as shown in FIGS. 11A to 11F, and a clipping processing which forms cut lines (clipping lines) so as to clip a processing tape T in arbitrary shapes including separated characters, as shown in FIGS. 12A to 12F. The control section 704 performs different kinds of controls by these half-cutting processing and clipping processing.

Hereafter, a series of control flows when the half-cutting processing and clipping processing are performed will be described. First, the half-cutting processing will be described taking as an example a case (see FIG. 11C) where half-cutting lines are formed in two front and rear spots in the tape feed direction. In a case where the half-cutting processing is performed, first, the control section 704 drives the printing feed motor 72 to supply and feed a processing tape T from the tape cartridge C. Then, when the processing tape T reaches the position where a front half-cutting line can be formed by this supply feed, the control section 704 stops the driving of the printing feed motor 72 to stop the supply and feed of the processing tape T and drives the disjunction motor 274 (for example, reverse driving) to bring the above-mentioned forward and backward feed roller 391 and the above-mentioned tension roller 392 into a grip state.

Next, after the control section 704 drives the cutting tool moving motor 341 to moves the cutting tool unit 131 (cutting tool 142) from the home position to the movement start position, the control section causes the cutting tool unit 131 to be further moved from the movement start position to the home position. In addition, for the sake of convenience of description, the description will be made assuming that the movement of the cutting tool unit 131 to the movement start position from the home position is a forward movement, the movement of the cutting tool unit to the home position from the movement start position is a backward movement, the home position side of the processing tape T is the bottom, and the movement start position side of the processing tape is the top.

At this time, the disjunction motor 274 is driven in synchronization with driving of the cutting tool moving motor 341 (driven forward). Also, if the cutting tool unit 131 faces an upper end of the processing tape T at the time of the backward movement of the cutting tool unit 131, the cutting tool unit 131 moves from a non-slitting position to a slitting position, to thereby perform a slitting operation on the processing tape T (in order to form the front half-cutting line). If the cutting tool unit 131 faces a lower end of the processing tape T, the cutting tool unit 131 moves from the slitting position to the non-slitting position, thereby completing the slitting operation.

After the slitting operation is completed, the control section 704 drives the disjunction motor 274 (reverse driving), to bring the forward and backward feed roller 391 and the tension roller 392 into a non-gripping state. Then, the control section 704 drives the printing feed motor 72 to resumes the supply and feed of the processing tape T, thereby feeding the processing tape T to a position where a rear half-cutting line can be formed. If the processing tape T is fed to the position where the rear half-cutting line can be formed, the control section 704 drives the disjunction motor 274 (reverse driving) to bring the forward and backward feed roller 391 and the tension roller 392 into a grip state, and thereafter performs the same control action as that when the front half-cutting line is formed, thereby forming the rear half-cutting line.

If the rear half-cutting line is formed, the control section 704 drives the cutting feed motor 393 (forward driving), to feed the processing tape T to the position where the cutting length of the processing tape T becomes a specified length. Then, after the full cutting motor 82 is driven (for example, driven forward) to cut the processing tape T to a specified length, the cutting feed motor 393 is again driven to eject the cut processing tape T from the tape ejecting slot 9.

In addition, although the above-mentioned half-cutting processing is a simple half-cutting processing in which a cutting line to be formed is a straight line parallel to the tape width direction, decorative half-cutting processing (trimming) can also be performed by, for example, rounding off the corners of the processing tape T and the half-cutting line (see FIG. 11D), and forming the half-cutting line into a nonlinear shape and a serrated shape (for example, see FIGS. 11E and 11F). In this case, the cutting feed motor 393 is driven in synchronization with driving of the cutting tool moving motor 341 for a slitting operation, to perform the forward and backward feed of the processing tape T in synchronization with the forward movement of the cutting tool unit 131 at the time of the slitting operation. Then, the sagging of the processing tape T caused by the backward feed at this time is absorbed (accommodated) by the above-mentioned tape buffer 125.

In fact, in the tape processing apparatus 1 of this embodiment, the simple half-cutting processing is set as a default. In the above-mentioned blade edge direction setting mechanism 138, the direction of the blade edge in the movement start position is set to correspond to the simple half-cutting processing. That is, in the blade edge direction setting mechanism 138, the blade edge of the cutting tool 142 which faces the movement start position is set to turn to the tape width direction (the forward movement direction). If the simple half-cutting processing is started to move the cutting tool carriage 134 from the movement start position, half-cutting lines parallel to the tape width direction can be formed rapidly.

In this way, in the half-cutting processing, if a processing tape T reaches a specified position where a half-cutting line can be formed in a predetermined position by the forward feed of the processing tape T, the slitting operation by the cutting tool unit 131 (cutting tool 142) is performed (sequentially), so that the cutting tool unit 131 performs the slitting operation on the non-cut processing tape T which is connected to the tape cartridge C. Therefore, the half-cutting processing can be performed efficiently and the time required for the half-cutting processing can be shortened.

Next, a case where the clipping processing is performed will be described. In the tape processing apparatus 1 of this embodiment, the clipping processing can be performed on a processing tape T having a width of 18 mm or more. In a case where the clipping processing is performed, the control section 704 first detects the width of a processing tape by the tape identification sensor 51, then drives the full cutting motor 82 on the basis of this detection (reverse driving), and causes (one pair of) the width guide members 521, which are corresponding to the width of the processing tape T as an object to be processed, to protrude to the tape feed path 31. Next, the control section 704 drives the printing feed motor 72, to supply and feed the processing tape T to the position where the cutting length of the processing tape T becomes a specified length. Subsequently, after the disjunction motor 274 is driven (reverse driving) to bring the forward and backward feed roller 391 and the tension roller 392 into a grip state, the full cutting motor 82 is driven (forward driving) to cut the processing tape T to a specified length.

Next, the control section 704 drives the cutting feed motor 393 (forward driving) to feed the processing tape T forward until the trailing end of the cut processing tape T reaches (exceeds) the above-mentioned branching portion. Subsequently, the cutting tool moving motor 341 is driven to move the cutting tool unit 131 (cutting tool 142) from the home position to the movement start position. Thereby, the first feed path 32 is blocked up at the branching portion 33 by the path change mechanism 124 (path opening/closing member 681). Next, the control section 704 drives the cutting feed motor 393 (reverse driving) to feed the processing tape T backward and rotate the above-mentioned take-up drum 602 for take-up. Accordingly, the trailing end of the processing tape T is fed to the second feed path 34, and when the processing tape T fed to the second feed path 34 reaches the tape accommodating section 601, the tape is wound up around the take-up drum 602.

If the leading edge of the processing tape T reaches the tension roller 392 by the backward feed of the processing tape T, a slitting operation is started to drive the cutting feed motor 393, the cutting tool moving motor 341, and the disjunction motor 274 synchronously. Accordingly, the forward and backward feed of the processing tape and the movement of the cutting tool 142 in the tape width direction are performed synchronously. Also, the disjunction of the cutting tool 142 is properly performed on the processing tape T and a clipping line which clips this processing tape into a prescribed shape is formed in the processing tape T. Then, if the processing tape T is clipped into a prescribed shape, the control section 704 drives the cutting feed motor 393 to eject the processed processing tape T from the tape ejecting slot 9.

Incidentally, the clipping processing is for forming clipping lines for arbitrary figures and characters in a processing tape T. As shown in FIGS. 12A and 12B, it is also possible to form clipping lines in a processing tape T which is not printed. As shown in FIGS. 12C to 12E, it is also possible to form clipping lines (decorative cut lines) (perform printing decoration cutting processing: complex processing) so as to surround a print image (characters, figures, etc.) printed on the processing tape T by the printing unit 41.

In this tape processing apparatus 1, the supply and feed (printing feed) of a processing tape T accompanying the printing processing is performed by the platen roller C6, and the forward and backward feed of a processing tape T accompanying the cutting processing is performed by the forward and backward feed roller 391. However, the feed rate (peripheral speed of the roller) of a processing tape T by the above-mentioned platen roller C6 and the feed rate of a processing tape T by the forward and backward feed roller 391 are adjusted with high accuracy, so that a print image and clipping lines can be positionally matched to each other by controlling rotation of both the rollers 391 and 392.

However, when there is an error, even if slight, in the tape feed rate of the platen roller C6 and the forward and backward feed roller 391 due to a mechanical tolerance, a mechanical installation error, aged deterioration, etc. As shown in FIGS. 12E and 12F, in a case where decorative cut lines are formed in each of the plurality of (two or more sets of) print images continuously printed on a processing tape T, this error cannot be ignored. That is, this error increases as it goes toward the trailing end of a processing tape T. As a result, there is a possibility that the formation position of a decorative cut line on a print image deviates. Accordingly, in a case where a printing decoration cut is performed on each of a plurality of (two or more sets of) print images in a printing decoration cutting processing, the control section 704 makes a control of performing supply and feed of a processing tape T accompanying printing by using the forward and backward feed roller 391, so that the positional deviation of each print image and a clipping line corresponding thereto can be prevented.

Specifically, the full cutting motor 82 is driven (reverse driving), to cause the width guide members 521, which are corresponding to the width of a processing tape T as an object to be processed, to protrude to the tape feed path 31. Thereafter, the printing feed motor 72 is driven to supply and feed the processing tape T until the leading edge of the processing tape T reaches the forward and backward feed roller 391. Subsequently, after the disjunction motor 274 is driven (reverse driving) to bring the forward and backward feed roller 391 and the tension roller 392 into a grip state, the cutting feed motor 393 and the print head 62 are driven synchronously. Accordingly, the processing tape T is supplied and fed by the forward and backward feed roller 391 (and tension roller 392) from the tape cartridge C, and printing (a plurality of printing images) is performed on the supplied and fed processing tape T.

Even after the printing processing to the processing tape T is completed, the driving (forward driving) of the cutting feed motor 393 is continued, and the processing tape T is supplied and fed to the position where the cutting length of the processing tape T becomes a specified length. Then, after the control section 704 drives the full cutting motor 82 (forward driving) and cuts the processing tape T to a specified length, the control section performs the same control as the above-mentioned clipping processing and performs printing decoration cutting on each print image printed on the processing tape T.

In this way, the supply and feed of a processing tape T accompanying printing processing and the forward and backward feed of the processing tape T accompanying clipping processing are performed using the same roller, so that the feed rate of processing tape T in each processing can be matched, and clipping lines can be formed on a print image with high accuracy.

What is claimed is:

1. A cutting device which performs cutting processing on a sheet for separated characters by reciprocating a cutting tool forward and backward in a direction which is orthogonal to a feed direction of the sheet for separated characters while the sheet for separated characters is fed forward and backward along a sheet feed path by a sheet feed section, the cutting device comprising:
a sheet accommodating section which accommodates the sheet for separated characters which is fed forward and backward so that the sheet can be loaded into and unloaded from the sheet accommodating section,
wherein the sheet accommodating section includes:
a take-up drum which winds up the fed sheet for separated characters into a roll shape; and
a power supply section which supplies the power for rotating the take-up drum for take-up.

2. The cutting device according to claim 1,
wherein the sheet accommodating section further includes an biasing member which biases the sheet for separated characters against a peripheral surface of the take-up drum.

3. The cutting device according to claim 1,
wherein the power supply section has a torque limiter which limits a rotational torque at the time of take-up of the take-up drum.

4. The cutting device according to claim 1,
wherein the sheet feed section has a sheet feed roller which rotates forward and backward to feed the sheet for separated characters forward and backward,
the power supply section has a reversible motor and a power transmission mechanism which transmits the power of the motor to the take-up drum, and
the power transmission mechanism transmits the forward and backward torque of the motor to the sheet feed roller.

5. The cutting device according to claim 4,
wherein the power transmission mechanism has a one-way clutch which transmits the forward and backward torque of the motor only in the direction of take-up of the take-up drum.

6. The cutting device according to claim 1,
wherein the sheet accommodating section further includes a housing member which accommodates the take-up drum, and an inner peripheral surface of the housing member is formed on a circle concentric with the take-up drum.

7. A sheet processing apparatus comprising:
the cutting device according to claim 1;
a printer which performs printing on the sheet for separated characters.
